(19) United States
(12) Patent Application Publication
(10) Pub. No.: US 2024/0216197 A1
(43) Pub. Date: Jul. 4, 2024

(54) Patient Support Apparatus With Deck Section Lift-Off Limiter

(71) Applicant: Stryker Corporation, Kalamazoo, MI (US)

(72) Inventors: Christopher Ryan Sweeney, Portage, MI (US); Matthew A. Cutler, Portage, MI (US)

(73) Assignee: Stryker Corporation, Kalamazoo, MI (US)

(21) Appl. No.: 18/390,075

(22) Filed: Dec. 20, 2023

Related U.S. Application Data
(60) Provisional application No. 63/436,180, filed on Dec. 30, 2022.

(51) Int. Cl. A61G 7/015

(52) U.S. Cl. CPC A61G 7/015; A61G 2203/70

(57) ABSTRACT

A patient support apparatus for use in treating patients with behavioral health indicia, the patient support apparatus comprising an intermediate frame and a patient support deck having a deck section arranged for movement relative to the intermediate frame between a plurality of deck section positions to define a plurality of predetermined patient support configurations. A limiter interposed between the intermediate frame and the deck section and including a track and a brace movable along the track in response to movement of the deck section, wherein engagement between the brace and the track simultaneously permits movement of the deck section between the plurality of deck section positions and retains the deck section relative to the intermediate frame to prevent unauthorized movement of the deck section away from the plurality of predetermined patient support configurations.

### CROSS-REFERENCE TO RELATED APPLICATION

The subject patent application claims priority to and all the benefits of U.S. Provisional Patent Application No. 63/436,180 filed on Dec. 30, 2022, the disclosure of which is hereby incorporated by reference in its entirety.

### BACKGROUND

Conventional Patient support apparatuses, such as hospital beds, stretchers, cots, tables, wheelchairs, and chairs are used to help caregivers facilitate care of patients in a health care setting. Conventional patient support apparatuses generally comprise a base and a patient support surface upon which the patient is supported. Often, these patient support apparatuses have one or more movable components, such as side rails that can be moved between raised and lowered positions, deck sections which articulate to adjust the patient support surface to support the patient between different patient support configurations, as well as lift mechanisms that adjust the height of the patient support surface.

In some environments, certain patients may present various forms of behavioral health indicia which can be associated with a potential risk of self-harm. Here, patients may sometimes attempt to inflict harm on themselves using components or portions of the patient support apparatus, including components arranged on the base as well as components arranged under deck sections. Certain patients may also attempt to tamper with components or portions of the patient support apparatus.

While patient support apparatuses have generally performed well for their intended purpose, there remains a need in the art to overcome one or more of the challenges described above.

### SUMMARY

The present disclosure provides a patient support apparatus for use in treating patients with behavioral health indicia. The patient support apparatus includes: an intermediate frame; a patient support deck having a deck section arranged for movement relative to the intermediate frame between a plurality of deck section positions to define a plurality of predetermined patient support configurations; and a limiter interposed between the intermediate frame and the deck section and including a track and a brace movable along the track in response to movement of the deck section, where engagement between the brace and the track simultaneously permits movement of the deck section between the plurality of deck section positions and retains the deck section relative to the intermediate frame to prevent unauthorized movement of the deck section away from the plurality of predetermined patient support configurations.

### BRIEF DESCRIPTION OF THE DRAWINGS

Advantages of the present invention will be readily appreciated as the same becomes better understood by reference to the following detailed description when considered in connection with the accompanying drawings.

FIG. 1 is perspective view of a patient support apparatus having a base, a litter with a patient support deck, a lift mechanism, and side rails.

FIG. 2 is an illustrative view of a control system of the patient support apparatus of FIG. 1.

FIG. 3A is a schematic right-side view of the patient support apparatus of FIG. 1, shown with each of the side rails arranged in a raised position.

FIG. 3B is another schematic right-side view of the patient support apparatus of FIG. 3A, shown with a first side rail arranged in an intermediate position, and shown with a second side rail arranged in the raised position.

FIG. 3C is another schematic right-side view of the patient support apparatus of FIGS. 3A-3B, shown with the first side rail arranged in a lowered position.

FIG. 4A is another schematic right-side view of the patient support apparatus of FIGS. 3A-3C, shown with two of the side rails removed for illustrative purpose, and with the lift mechanism supporting the litter in a raised configuration.

FIG. 4B is another schematic right-side view of the patient support apparatus of FIG. 4A, shown with the lift mechanism supporting the litter in a lowered configuration.

FIG. 5 is another schematic right-side view of the patient support apparatus of FIG. 4B, shown with the patient support deck having a back section arranged in a fowler's position with the second side rail coupled to the back section.

FIG. 6 is another schematic right-side view of the patient support apparatus of FIG. 5, shown with the lift mechanism supporting the litter in an inclined configuration.

FIG. 7 is a perspective view of the litter of the patient support apparatus of FIGS. 1, shown having a back section, a seat section, a leg section, and a foot section each arranged in raised positions to define a first patient support configuration, and limiters operatively attached to the foot section and to the seat section to prevent unauthorized movement away from the first patient support configuration.

FIG. 8A is another perspective view of the litter of FIG. 7, shown with the back section, the seat section, the leg section, and the foot section each arranged in lowered positions to define a second patient support configuration.

FIG. 8B is another perspective view of the litter of FIG. 8A, shown with the back section and the seat section each arranged in respective intermediate positions.

FIG. 8C is another perspective view of the litter of FIG. 8B, shown with the back section and the seat section each arranged in respective raised positions.

FIG. 8D is another perspective view of the litter of FIG. 8C, shown with the leg section and the foot section each arranged in respective intermediate positions.

FIG. 8E is another perspective view of the litter of FIG. 8D, shown with the leg section and the foot section each arranged in respective raised positions.

FIG. 9A is a left-side plan view of the litter arranged as depicted in FIG. 8A.

FIG. 9B is a left-side plan view of the litter arranged as depicted in FIG. 8B.

FIG. 9C is a left-side plan view of the litter arranged as depicted in FIG. 8C.

FIG. 9D is a left-side plan view of the litter arranged as depicted in FIG. 8D.

FIG. 9E is a left-side plan view of the litter arranged as depicted in FIG. 8E.

FIG. 10 is another left-side plan view of the litter of FIGS. 7-9E, shown with the deck sections arranged in respective intermediate positions, and shown depicting unauthorized movement paths for the foot section and the seat section that are prevented by the limiters.

FIG. 11A is an enlarged, partial detail view taken at indicia 11A in FIG. 9A.

FIG. 11B is an enlarged, partial detail view taken at indicia 11A in FIG. 9B.

FIG. 11C is an enlarged, partial detail view taken at indicia 11A in FIG. 9C.

FIG. 12A is an enlarged, partial detail view taken at indicia 11A in FIG. 9C.

FIG. 12B is an enlarged, partial detail view taken at indicia 11A in FIG. 9D.

FIG. 12C is an enlarged, partial detail view taken at indicia 11A in FIG. 9E.

FIG. 13A is an enlarged, partial perspective view of portions of the litter of FIGS. 7-10, depicting the limiter operatively attached to the foot section, the limiter shown having a bracket defining a track and a brace supported for movement along the track.

FIG. 13B is an enlarged, exploded, partial perspective view of the portions of the litter of FIG. 13A, shown with the brace and the bracket defining the track spaced from the litter.

FIG. 14 is an enlarged perspective view of the bracket of FIG. 13B.

FIG. 15A is an enlarged, partial perspective view of portions of the litter of FIGS. 7-10, depicting the limiter operatively attached to the seat section, the limiter shown having a bracket defining a track and a brace supported for movement along the track.

FIG. 15B is an enlarged, exploded, partial perspective view of the portions of the litter of FIG. 15A, shown with the brace and the bracket defining the track spaced from the litter.

FIG. 16 is an enlarged perspective view of the bracket of FIG. 15B.

### DETAILED DESCRIPTION

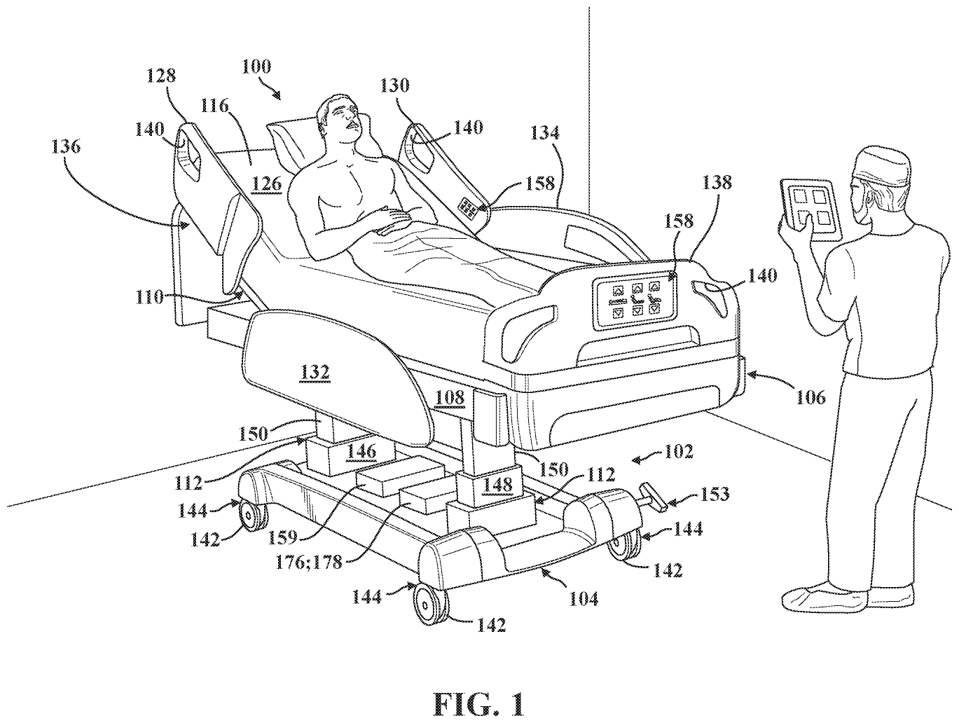

Referring to the drawings, wherein like numerals indicate like or corresponding parts throughout the several views, a patient support apparatus 100 and portions of a facility F are shown in FIG. 1. The patient support apparatus 100 supports a patient in a heath care setting, such as within a facility F realized as a hospital or another setting for treating patients. The patient support apparatus 100 illustrated throughout the drawings is realized as a hospital bed. In other versions, however, the patient support apparatus 100 may be a stretcher, a cot, a table, a wheelchair, a chair, or a similar apparatus utilized in the care of a patient.

The patient support apparatus 100 includes a support structure 102 which provides support for the patient. In the representative version illustrated herein, the support structure 102 generally comprises a base 104 and a litter 106. Here, the litter 106 includes an intermediate frame 108 and a patient support deck 110 spaced above the base 104. As is described in greater detail below, a lift mechanism 112 is interposed between the base 104 and the intermediate frame 108 to facilitate moving the litter 106 relative to the base 104 between a plurality of vertical configurations/poses, including without limitation one or more raised configurations, lowered configurations, and/or inclined configurations such as a Trendelenburg configuration.

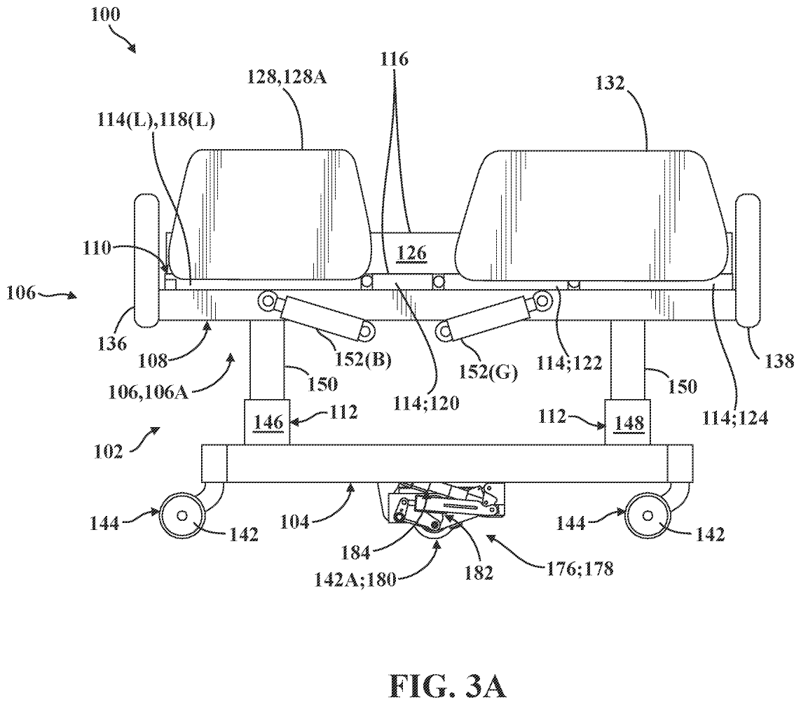

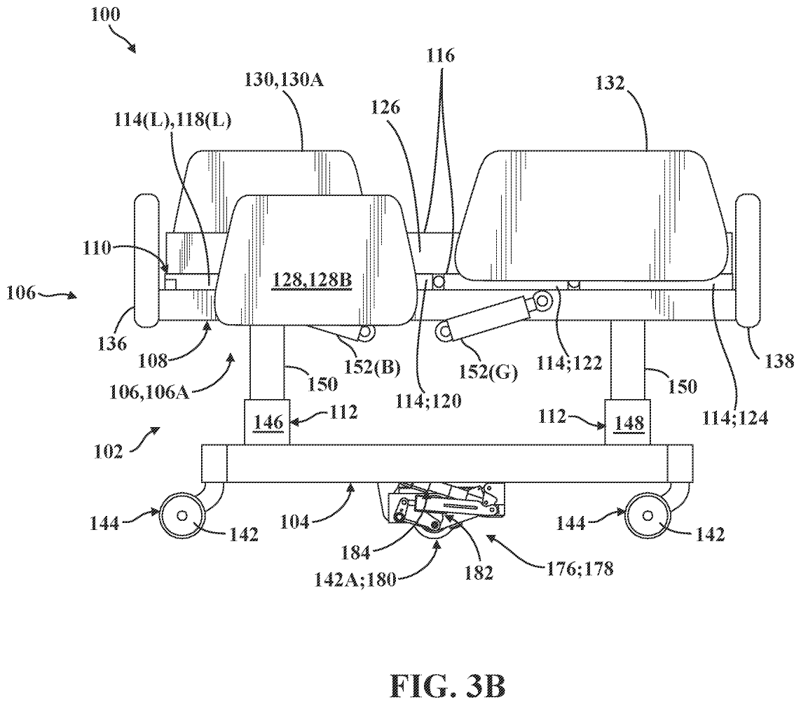

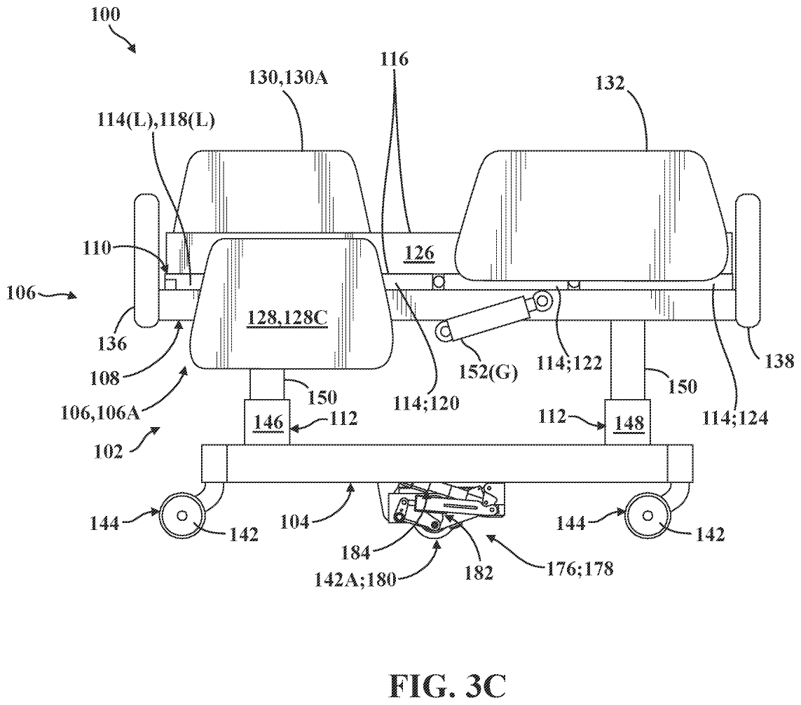

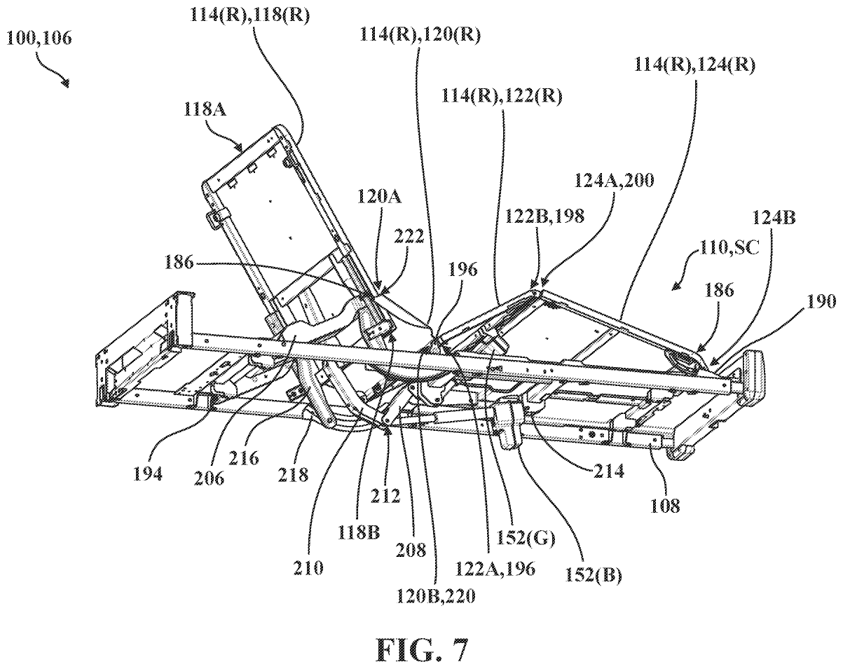

The patient support deck 110 has at least one deck section 114 arranged for movement relative to the intermediate frame 108 between a plurality of section positions 114L, 114R, 114I. The deck sections 114 of the patient support deck 110 provide a patient support surface 116 upon which the patient is supported. More specifically, in the representative version of the patient support apparatus 100 illustrated herein, the patient support deck 110 has four deck sections 114 which cooperate to define the patient support surface 116: a back section 118, a seat section 120, a leg section 122, and a foot section 124 (see FIGS. 3A-6). In the representative version illustrated herein, and as is described in greater detail below, the seat section 120 is pivotably coupled to the intermediate frame 108 and is disposed in sliding engagement with the back section 118. However, it will be appreciated that the seat section 120 could be fixed relative to the intermediate frame 108 in some versions. The back section 118 and the leg section 122 are arranged for independent movement relative to each other and to the intermediate frame 108, as described in greater detail below, and the foot section 124 is arranged to move partially concurrently with the leg section 122. Other configurations are contemplated, and it will be appreciated that different arrangements of deck sections 114 are contemplated by the present disclosure. By way of non-limiting example, the patient support deck 110 could be configured without a discrete seat section 120 in some versions. Furthermore, while the representative version of the litter 106 illustrated herein employs the intermediate frame 108 to support the deck sections 114 of the patient support deck 110 for movement relative to the base 104 via the lift mechanism 112, it will be appreciated that various types of litters 106, with or without discrete intermediate frames 108 and/or with a differently-configured lift mechanism 112, are contemplated by the present disclosure. In some versions, the patient support deck 110 and its associated deck sections 114 may be similar to as is described in U.S. Pat. No. 11,116,680, entitled “Patient Support Apparatus for Controlling Patient Ingress and Egress,” the disclosure of which is hereby incorporated by reference in its entirety. Aspects of the patient support deck 110 will be described in greater detail below in connection with FIGS. 7-10.

A mattress 126 may be disposed on the patient support deck 110 during use. The mattress 126 comprises or otherwise defines the patient support surface 116 upon which the patient is supported, but it will be appreciated that its shape is defined based on the arrangement of the patient support deck 110. Here too, it will be appreciated that the patient support deck 110 itself would define the patient support surface 116 during operation of some versions of the patient support apparatus 100 without the mattress 126. Put differently, the mattress 126 may be omitted in certain versions, such that the patient can rest directly on the patient support surface 116 defined by the deck sections 114 of the patient support deck 110. The base 104, the litter 106, the intermediate frame 108, and the patient support deck 110 each have a head end and a foot end corresponding to designated placement of the patient's head and feet on the patient support apparatus 100. It will be appreciated that the specific configuration of the support structure 102 may take on any known or conventional design and is not limited to that specifically illustrated and described herein. Other configurations are contemplated.

Side rails 128, 130, 132, 134 are coupled to the support structure 102 via mounts and are supported for movement relative to the intermediate frame 108 (and, thus, relative to the base 104). A first side rail 128 is positioned at a right head end of the litter 106. A second side rail 130 is positioned at a left head end of litter 106. A third side rail 132 is positioned at a right foot end of the litter 106. A fourth side rail 134 is positioned at a left foot end of the litter 106. One or more of the side rails may be coupled to one or mounts via linkages and may be movable between a plurality of side rail positions, including a raised position, in which they block ingress and egress into and out of the patient support apparatus 100, one or more intermediate positions, and a lowered position in which they are not an obstacle to such ingress and egress across the periphery of the patient support surface 116. It will be appreciated that there may be fewer side rails for certain versions, such as where the patient support apparatus 100 is realized as a stretcher or a cot. Similarly, it will be appreciated that side rails may be attached to any suitable component or structure of the patient support apparatus 100, and that their respective mount and/or linkage may be configured in various ways. In some versions, the side rails 128, 130, 132, 134 or other portions of the patient support apparatus 100 may be similar to as is described in U.S. Patent Application Publication No. US 2021/0338504 A1, entitled “Side Rail Assembly For A Patient Support Apparatus,” the disclosure of which is hereby incorporated by reference in its entirety. Other configurations are contemplated. In the representative version illustrated herein, the first and second side rails 128, 130 are coupled to the back section 118 of the patient support deck 110 and move concurrently therewith.

As shown in FIG. 1, a headboard 136 and a footboard 138 are coupled to respective mounts of the intermediate frame 108 of the litter 106. However, it will be appreciated that the headboard 136 and/or footboard 138 may be coupled to other locations on the patient support apparatus 100, such as the base 104, or may be omitted in certain versions. One or more caregiver interfaces 140, such as handles, are shown in FIG. 1 as being integrated into the first and second side rails 128, 130 to facilitate movement of the patient support apparatus 100 over floor surfaces. Additional caregiver interfaces 140 may be integrated into the headboard 136, the footboard 138, and/or other components of the patient support apparatus 100, such as the third and/or fourth side rails 132, 134, the intermediate frame 108, and the like. The caregiver interfaces 140 are shaped so as to be grasped by a caregiver as a way to position or otherwise manipulate the patient support apparatus 100 for movement. It will be appreciated that the caregiver interfaces 140 could be integrated with or operatively attached to any suitable portion of the patient support apparatus 100 or may be omitted in certain versions.

Wheels 142 are coupled to the base 104 to facilitate transportation over floor surfaces. The wheels 142 are arranged in each of four quadrants of the base 104, adjacent to corners of the base 104. In the version shown in FIG. 1, the wheels 142 are caster wheels that are able to rotate and swivel relative to the support structure 102 during transport. Here, each of the wheels 142 forms part of a caster assembly 144 mounted to the base 104. In the illustrated version, the patient support apparatus 100 includes a brake assembly 153 operatively attached to one or more of the wheels 142 and being operable between a braked state to inhibit movement of the base 104 about floor surfaces, and an unbraked state to permit movement of the base 104 about floor surfaces. In some versions, the wheels 142 and brake assembly 153 may be similar to as is disclosed in U.S. Pat. No. 10,806,653, entitled “Patient Transport Apparatus With Electro-Mechanical Braking System,” and/or International Patent Application Publication No. WO 2021/138176 A1, entitled “Patient Transport Apparatus With Electro-Mechanical Braking System,” the disclosures of each of which are hereby incorporated by reference in their entirety. Other configurations are contemplated.

It should be understood that various configurations of the caster assemblies 144 are contemplated. In addition, in some versions, the wheels 142 are not caster wheels. Moreover, it will be appreciated that the wheels 142 may be non-steerable, steerable, non-powered, powered, or combinations thereof. While the representative version of the patient support apparatus 100 illustrated herein employs four wheels 142, additional wheels are also contemplated. For example, the patient support apparatus 100 may comprise four non-powered, non-steerable wheels, along with one or more additional powered wheels. In some cases, the patient support apparatus may not include any wheels. In other versions, one or more auxiliary wheels (powered or non-powered), which are movable between stowed positions and deployed positions, may be coupled to the support structure 102. In some cases, when auxiliary wheels are located between caster assemblies 144 and contact the floor surface in the deployed position, they cause two of the caster assemblies 144 to be lifted off the floor surface, thereby shortening a wheel base of the patient support apparatus 100. A fifth wheel may also be arranged substantially in a center of the base 104.

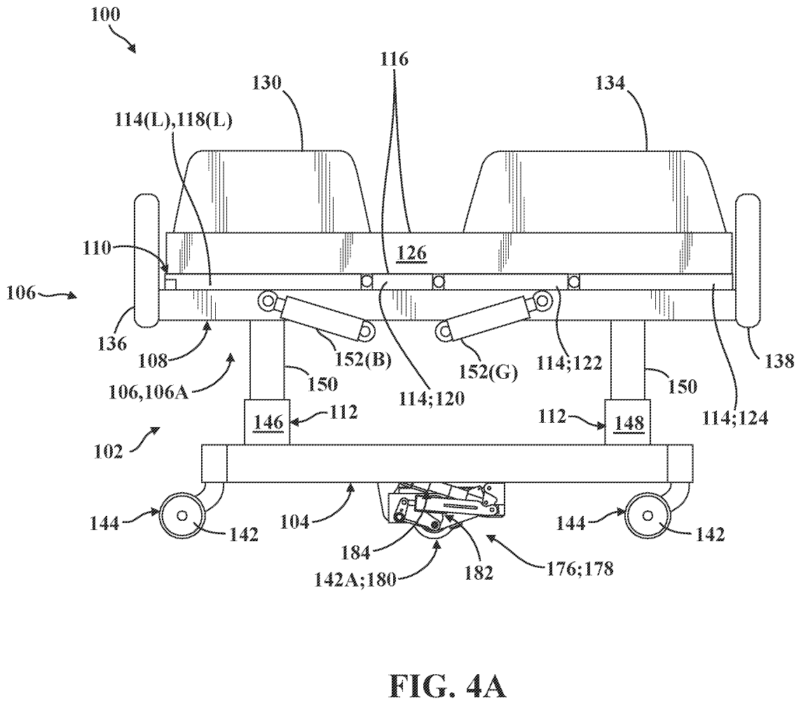

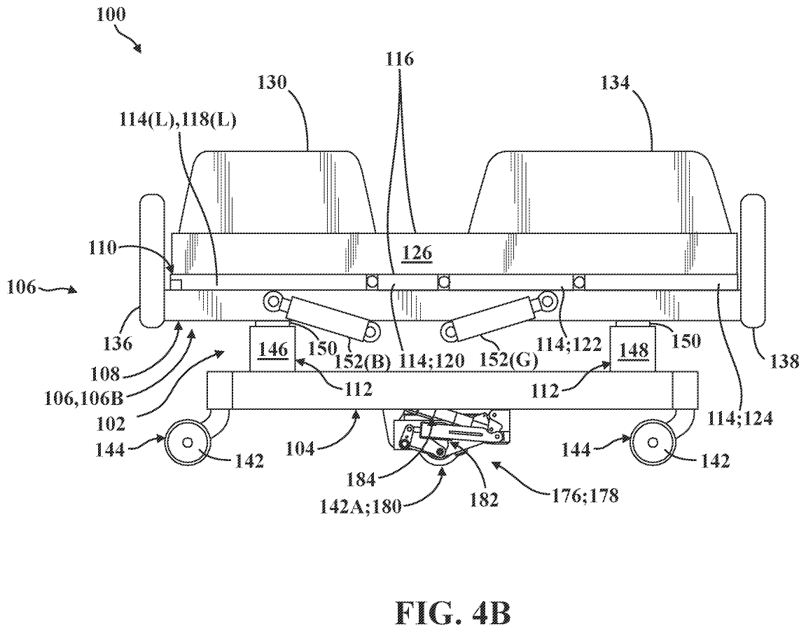

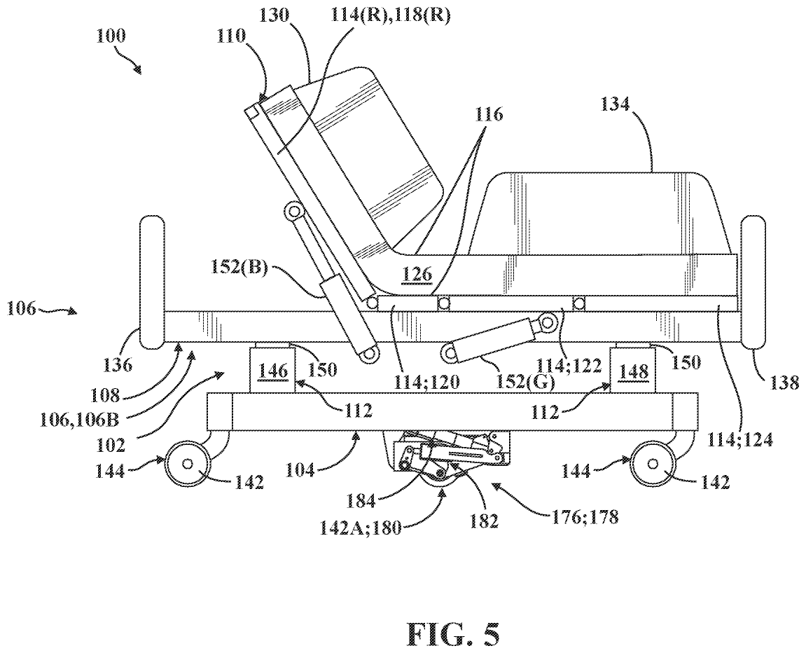

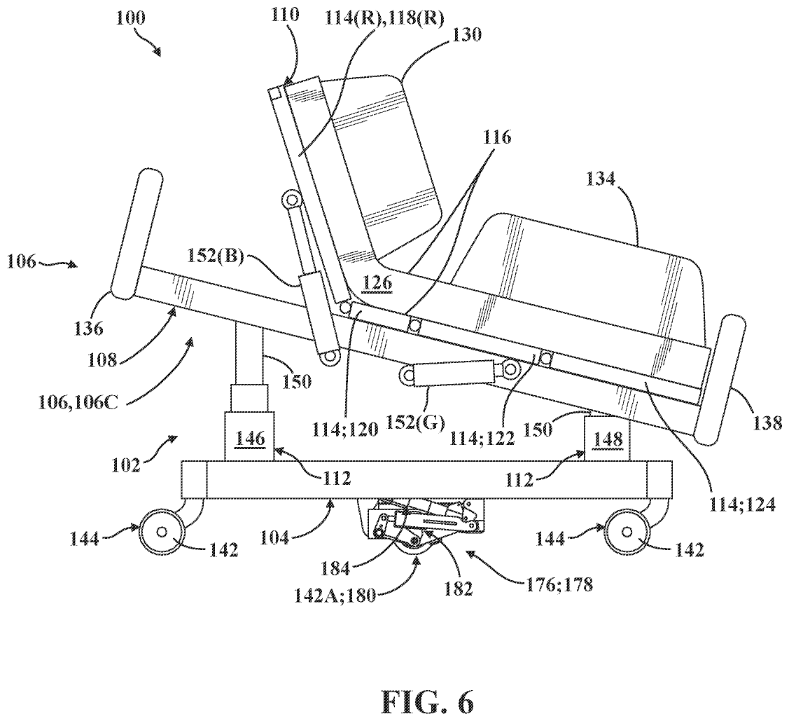

As noted above, the patient support apparatus 100 employs the lift mechanism 112 to lift and lower the litter 106 relative to the base 104 which, in turn, moves the intermediate frame 108 together with the patient support deck 110 between various vertical configurations, such as to the raised vertical configuration 106A depicted in FIGS. 3A-4A, the lowered vertical configuration 106B depicted in FIGS. 4B-5, or to any desired vertical configuration therebetween including various inclined configurations such as is depicted in FIG. 6. To this end, the lift mechanism 112 may include a head end lift member 146 and a foot end lift member 148 which are each arranged to facilitate movement of the litter 106 with respect to the base 104 using one or more lift actuators 150. The lift actuators 150 may be realized as linear actuators, rotary actuators, or other types of actuators, and may be electrically operated and/or may be hydraulic. It is contemplated that, in some configurations, only one lift member and one associated lift actuator may be employed, e.g., to raise only one end of the litter 106 (see FIG. 6), or one central lift actuator to raise and lower the litter 106. The construction of the lift mechanism 112, the head end lift member 146, and/or the foot end lift member 148 may take on any known or conventional design, and is not limited to that specifically illustrated. By way of non-limiting example, the lift mechanism 112 could comprise a “scissor” linkage arranged between the base 104 and the litter 106 with one or more actuators configured to facilitate vertical movement of the patient support deck 110. In some versions, the lift mechanism 112 may be similar to as is described in U.S. Pat. No. 10,172,753, entitled “Patient Support Lift Assembly,” the disclosure of which is hereby incorporated by reference in its entirety. Other configurations are contemplated.

As noted above, the patient support deck 110 is operatively attached to the intermediate frame 108 (e.g., as depicted in FIGS. 1 and 3A-6), with one or more of the deck sections 114 arranged for movement between a first section position 114L (see FIGS. 3A-4B) and a second section position 114R (see FIGS. 5-6). To this end, one or more deck actuators 152 are interposed between the deck section 114 and the intermediate frame 108 to move the deck section 114. In the representative versions illustrated herein, the deck actuator 152 is realized as a linear actuator disposed in force-translating relationship between the deck section 114 and the intermediate frame 108. More specifically, one deck actuator 152 is provided between the intermediate frame 108 and the back section 118, and another deck actuator 152 is provided between the intermediate frame 108 and the leg section 122, and each of the deck actuators 152 is arranged for independent movement to position the respective deck sections 114 to adjust the shape of the patient support surface 116 between a plurality of patient support configurations (for example, a flat configuration, a raised fowler configuration, a seated configuration, etc.). Here, the deck actuator 152 coupled to the back section 118 is configured to move the back section 118 between the first section position 114L (see FIGS. 3A-4B), the second section position 114R (see FIGS. 5-6), as well as to additional section positions between the first and second section positions 114L, 114R and/or to section positions beyond the second section position 114R.

Those having ordinary skill in the art will appreciate that the patient support apparatus 100 could employ any suitable number of deck actuators 152, of any suitable type or configuration sufficient to effect selective movement of one or more of the deck sections 114 relative to the litter 106 or other components of the support structure 102. By way of non-limiting example, the deck actuator 152 could be a linear actuator or one or more rotary actuators driven electronically and/or hydraulically, and/or controlled or driven in any suitable way. Moreover, the deck actuator 152 could be mounted, secured, coupled, or otherwise operatively attached to the intermediate frame 108 and to the deck section 114, either directly or indirectly, in any suitable way. In addition, one or more of the deck actuators 152 could be omitted for certain applications.

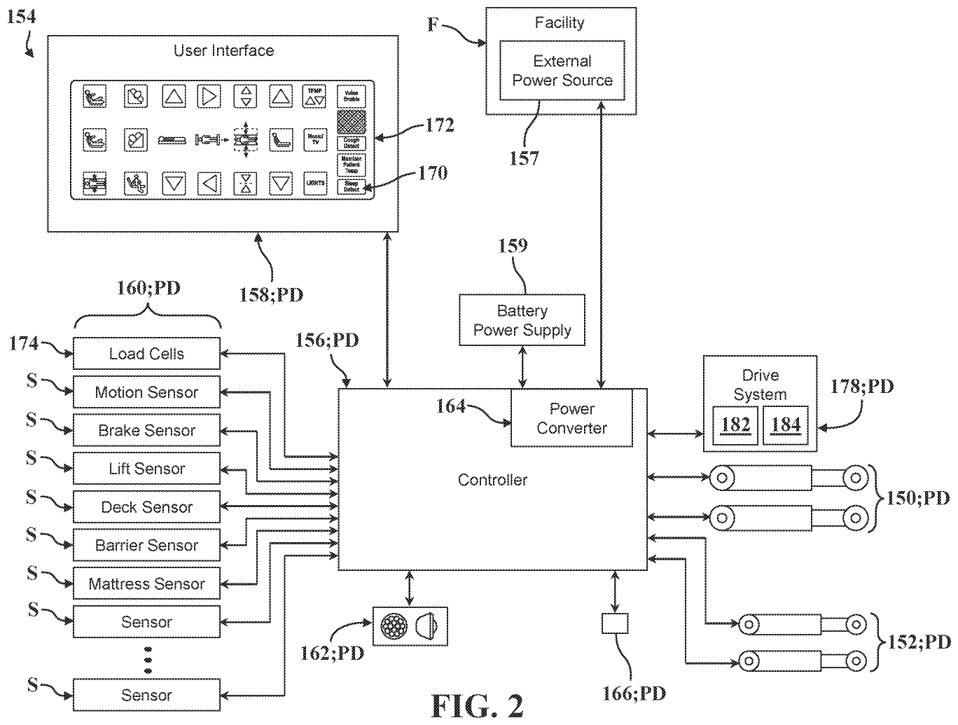

Referring to FIG. 2, the patient support apparatus 100 employs a control system, generally indicated at 154, to effect operation of various functions of the patient support apparatus 100 by powering, driving, communicating with, or otherwise controlling various types of powered devices PD, as described in greater detail below. To this end, and as is shown schematically in FIG. 2, the control system 154 generally includes an apparatus controller 156 disposed in communication with one or more user interfaces 158 adapted for use by the patient and/or the caregiver to facilitate operation of one or more functions of the patient support apparatus 100. The apparatus controller 156 may also be directly or indirectly disposed in communication with powered devices PD, including without limitation the lift actuators 150, the deck actuators 152, one or more sensors S of a sensor system 160, a communication interface 162 for communicating with various remote devices (e.g., smartphones, external systems, and the like), one or more power converters 164, a drive system 178, and/or one or more additional powered devices 166 such as devices to adjust the length and/or width of the litter 106, devices to turn the patient, devices to facilitate ingress and/or egress, devices to facilitate actuation of electric brakes, devices to monitor patient movement and/or bed exit, and the like. Other configurations are contemplated.

In the representative version illustrated in FIGS. 1 and 2, the patient support apparatus 100 comprises a plurality of user interfaces 158 which may be accessible by the patient, the caregiver, or by both the caregiver and the patient. Each user interface 158 of the patient support apparatus 100 generally comprises an input device 170 configured to generate an input signal in response to activation by a user which, in turn, is communicated to the apparatus controller 156. The apparatus controller 156, in turn, is responsive to the input signal and can control or otherwise carry out one or more functions of the patient support apparatus 100 in response to receiving the input signal. Put differently, the apparatus controller 156 is configured to perform a function of the patient support apparatus 100 in response to receiving the input from the input device 170. By way of non-limiting example, the input device 170 could be realized as a “lift bed” button, activation of which causes the apparatus controller 156 to drive the lift actuators 150 to move the intermediate frame 108 of the litter 106 from the maximum lowered configuration vertically away from the base 104 towards the raised configuration.

In some versions, one or more of the user interfaces 158 may also employ an output device 172, such as a screen, one or more audible and/or visual indicators (e.g., speakers, beepers, light emitting diodes LEDs, and the like), to communicate information to the user (e.g., to the caregiver). In some versions, the user interface 158 may be realized as a touchscreen interface that serves as both the input device 170 and the output device 172. In some versions, the apparatus controller 156 may be configured to facilitate navigation of visual content of the user interface 158 (e.g., realized as a graphical user interface GUI) in response to receiving the input signal from the input device 170. Thus, it will be appreciated that the user interface 158 could be configured in a number of different ways sufficient to generate the input signal. Moreover, it will be appreciated that the user interfaces 158 could be of a number of different styles, shapes, configurations, and the like. By way of non-limiting example, one or more of the user interfaces 158 may comprise buttons, indicators, screens, graphical user interfaces, and the like. Other configurations are contemplated.

In some versions, one or more portions of the sensor system 160 may be coupled to the support structure 102 to generate data representing load acting on the support structure 102. To this end, as is depicted schematically in FIG. 2, the sensor system 160 may include a plurality of load cells 174 interposed in force-translating relation between the intermediate frame 108 and the base 104 to measure load acting on the support structure 102 (not shown in detail). Here, each load cell 174 generates a respective output signal representing the amount of weight sensed thereby. In some versions, a total of four load cells 174 are interposed between the intermediate frame 108 and the lift members 146, 148 of the lift mechanism 112 to measure load (e.g., patient weight) acting about the patient support surface 116 as well as on other portions of the intermediate frame 108 or components coupled thereto. It will be appreciated that other arrangements of load cells 174 are contemplated by the present disclosure, and different quantities of load cells 174 arranged in various ways may be employed by the sensor system 160. By way of non-limiting example, load cells could be interposed between the base 104 and the lift mechanism 112 (not shown). In some versions, aspects of the patient support apparatus 100, including the arrangement of load cells 174 about support structures 102, may be similar to as is described in International Patent Application Publication No. WO 2021/242946 A1, entitled “Lift Systems And Load Cells For Patient Support Apparatus;” International Patent Application Publication No. WO 2021/108377, entitled “Patient Support Apparatus With Load Cell Assemblies;” and/or U.S. Patent Application Publication No. US 2021/0030611 A1, entitled “Patient Support Apparatus With Load Cell Assemblies;” the disclosures of each of which are hereby incorporated by reference in their entirety. Other configurations are contemplated.

In some versions, the sensor system 160 may include one or more different types of sensors S for determining changes in the position, state, or operation of various portions of the patient support apparatus 100, and or changes in patient position, status, condition, and the like. In some versions, the patient support apparatus 100 may include one or more sensors S disposed in communication with the apparatus controller 156 to: determine motion of the patient support apparatus 100, to determine operation of the brake assembly 153 (e.g., between braked and unbraked states), to determine an arrangement of the intermediate frame 108 relative to the base 104, to determine movement of one or more deck sections 114, to determine movement of the side rails 128, 130, 132, 134 and/or the headboard 136 or the footboard 138, to determine movement of the mattress 126, and/or to determine changes in the position or status of the patient. It will be appreciated that various sensors S of a number of different types, styles, and/or configurations may be employed, including without limitation limit switches, touch sensors, potentiometers, encoders, pressure sensors, temperature sensors, humidity sensors, optical sensors (e.g., cameras), or other type of sensors responsive to changes in position, contact, orientation, state, and the like. In some versions, the functionality afforded by sensors S could be realized as code operated by the apparatus controller 156 or other portions of the patient support apparatus 100. Other configurations are contemplated.

Referring to FIGS. 3A-6, in some versions, the patient support apparatus 100 includes an auxiliary wheel assembly 176 coupled to the base 104. The auxiliary wheel assembly 176 forms part of a drive system 178 configured to influence motion of the patient support apparatus 100 during transportation over floor surfaces. To this end, the drive system 178 generally includes a drive member 180 and a motor 182 coupled to the drive member 180 to operate the drive member 180 at various speeds. In the illustrated versions, the drive member 180 is realized as an auxiliary wheel 142A. However, those having ordinary skill in the art will appreciate that the drive system 178 could be configured in other ways, with various types of drive members 180 other than those configured as auxiliary wheels 142A of auxiliary wheel assemblies 176. By way of non-limiting example, the drive member 180 could be realized by various types and/or arrangements of one or more belts, treads, wheels, tires, and the like, which may be arranged in various ways about the patient support apparatus 100 and may be deployable, retractable, or similarly movable, or may be generally engaged with the floor surface (e.g., realized as powered wheels at one or more corners of the base 104). Other configurations are contemplated. Accordingly, it will be appreciated that the auxiliary wheel drive system 178 described and illustrated herein represents one type of drive system 178 contemplated by the present disclosure, and the auxiliary wheel 142A described and illustrated herein represents one type of drive member 180 contemplated by the present disclosure.

The auxiliary wheel assembly 176 employs an auxiliary wheel actuator 184 operatively coupled to the auxiliary wheel 142A and operable to move the auxiliary wheel 142A between one or more deployed positions engaging the floor surface, and one or more retracted positions spaced away from and out of contact with the floor surface. The auxiliary wheel 142A influences motion of the patient support apparatus 100 during transportation over the floor surface when the auxiliary wheel 142A is in a deployed position. In some versions, the auxiliary wheel assembly 176 comprises an additional auxiliary wheel movable with the auxiliary wheel via the auxiliary wheel actuator 184. It will be appreciated that operation of the drive system 178 may be effected in various ways, including such as based on signals from the sensor system 160, one or more sensors S, and/or one or more user interfaces 158. In some versions, aspects of the drive system 178 may be similar to as is disclosed in one or more of: U.S. patent application Ser. No. 16/690,217, filed on Nov. 21, 2019, entitled, “Patient Transport Apparatus With Controlled Auxiliary Wheel Deployment;” U.S. patent application Ser. No. 17/131,947, filed on Dec. 23, 2020, entitled, “Patient Transport Apparatus With Controlled Auxiliary Wheel Speed;” and/or U.S. patent application Ser. No. 17/132,009, filed on Dec. 23, 2020, entitled, “Patient Transport Apparatus With Auxiliary Wheel Control Systems;” the disclosures of each of which are hereby incorporated by reference in their entirety. Other configurations are contemplated.

As noted above, the apparatus controller 156 is depicted schematically in FIG. 2 and has been omitted from certain drawings for the purposes of clarity and consistency. It will be appreciated that the apparatus controller 156 and/or the control system 154 can be configured or otherwise arranged in a number of different ways to facilitate operation of the patient support apparatus 100. The apparatus controller 156 may have one or more microprocessors for processing instructions or for processing an algorithm stored in memory to control operation of powered devices PD, generation or interpretation of signals and/or data (e.g., data from sensors S, the sensor system 160, and the like), communication with the user interfaces 158 and/or remote devices (e.g., portable electronic devices), performance of one or more functions of the powered devices PD, and the like. Additionally or alternatively, the apparatus controller 156 may comprise one or more microcontrollers, field programmable gate arrays, systems on a chip, discrete circuitry, and/or other suitable hardware, software, or firmware that is capable of carrying out the various functions and operations described herein. The apparatus controller 156 may be carried on-board the patient support apparatus 100, such as on the base 104 or the litter 106, or may be remotely located. The apparatus controller 156 may comprise one or more sub-controllers configured to control powered devices PD or one or more sub-controllers for each powered device PD. The apparatus controller 156 and/or other parts of the control system 154 may communicate with the powered devices PD (e.g., the actuators 150, 152, the user interfaces 158, and the like) via wired and/or wireless communication. Power used to operate the powered devices PD, as well as the apparatus controller 156 itself, can be provided by an external power source 157 and/or by a battery 159 operatively coupled to the support structure 102.

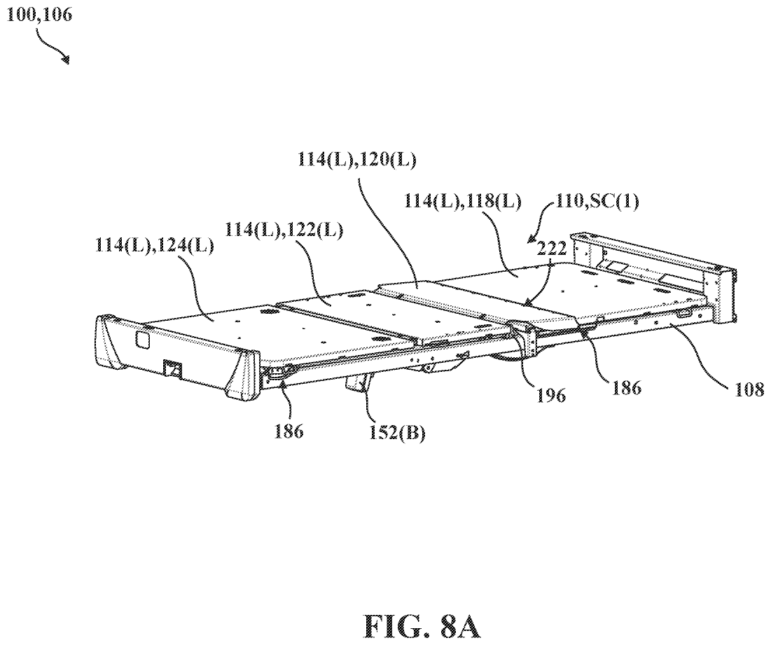

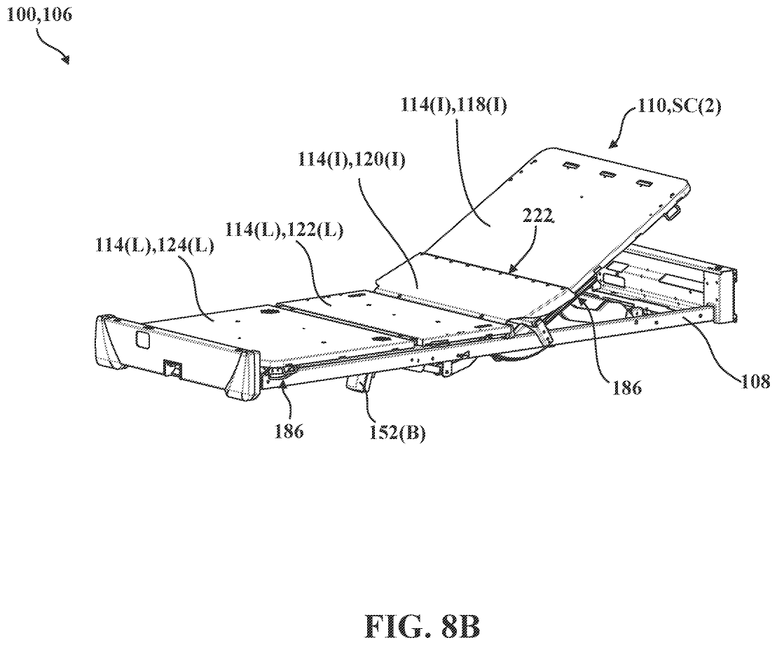

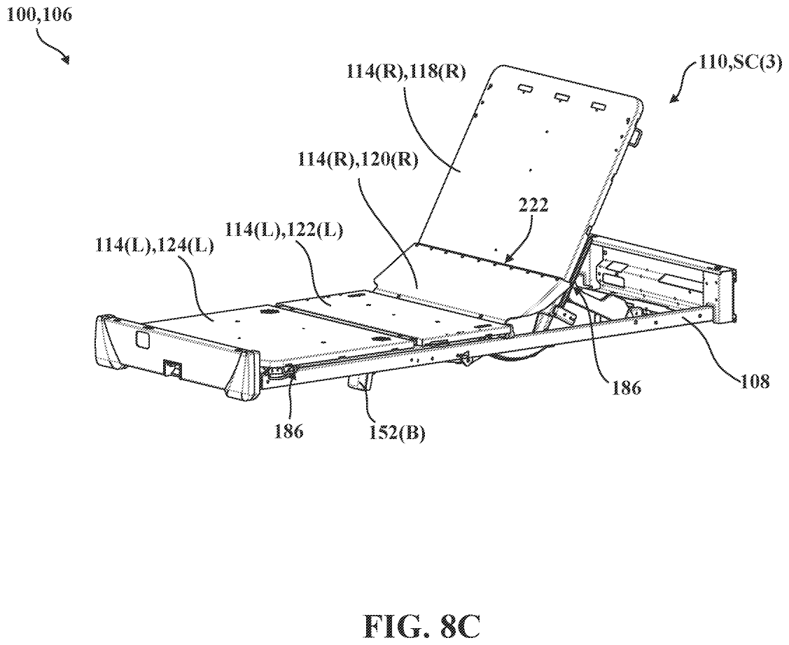

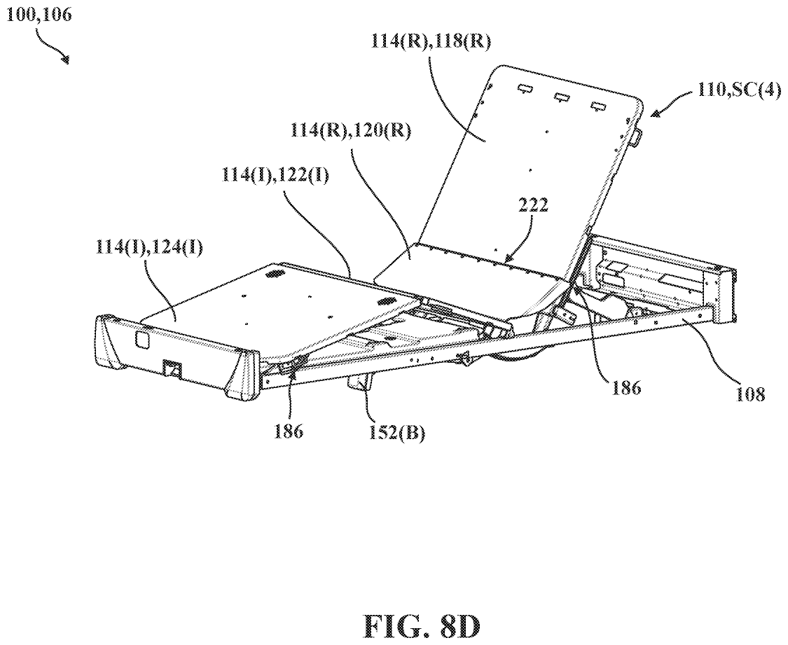

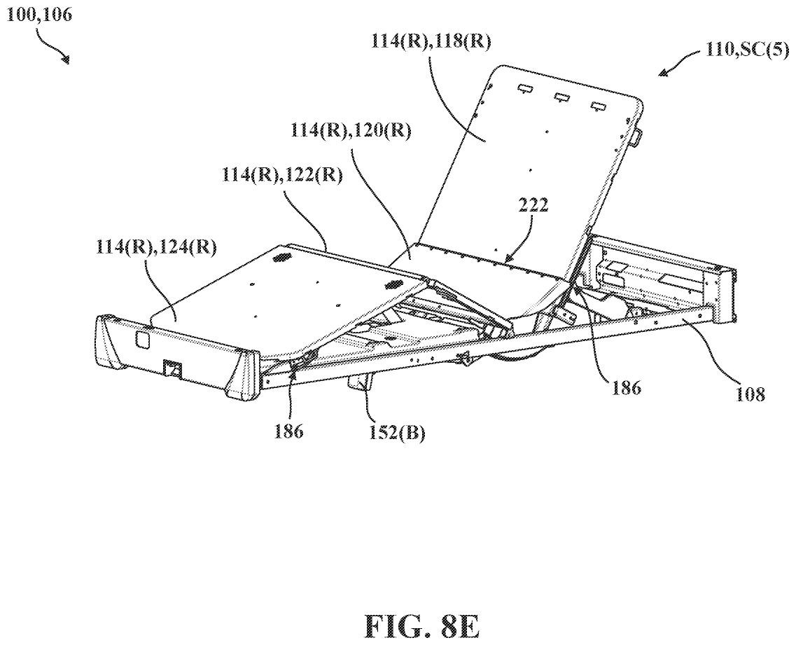

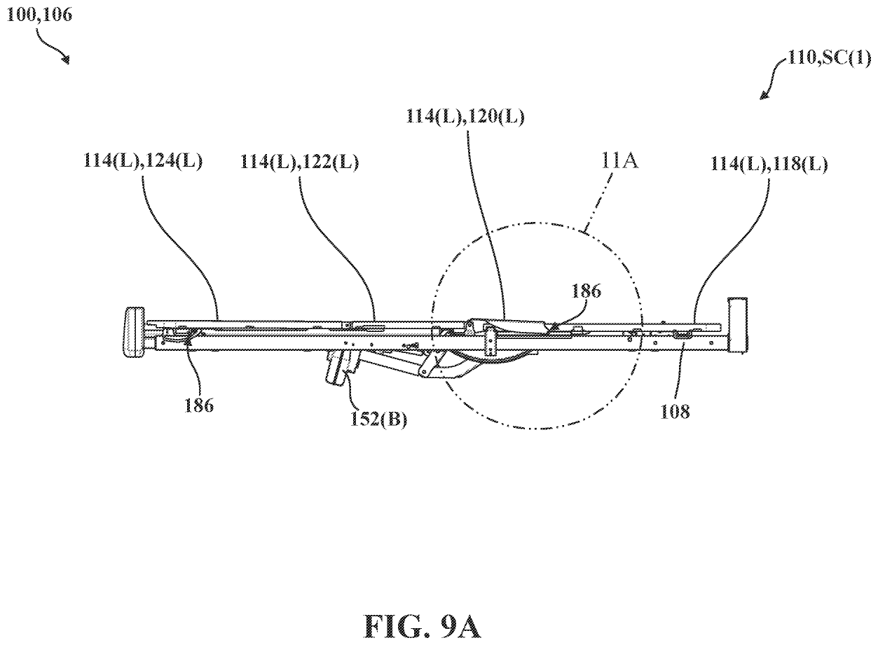

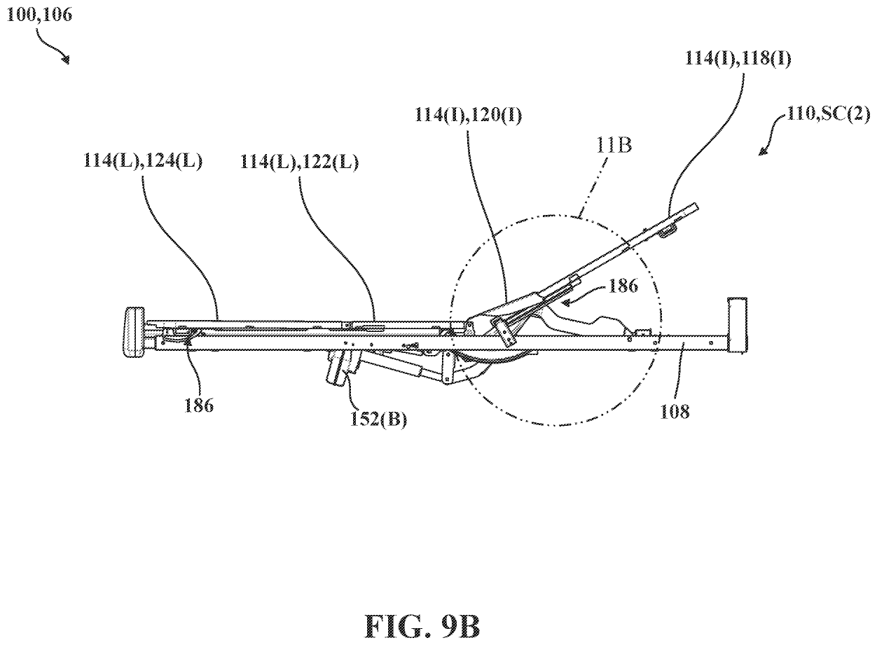

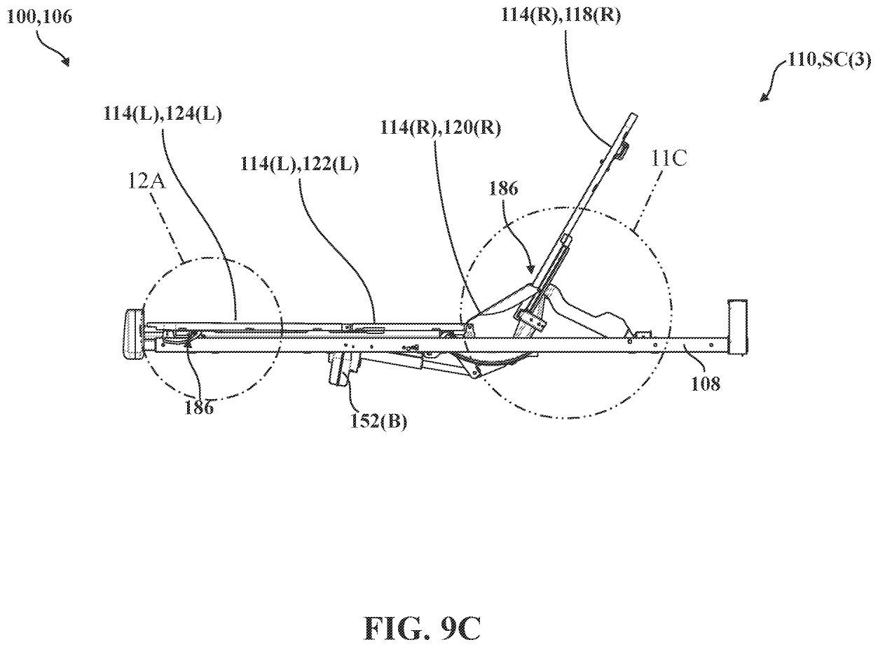

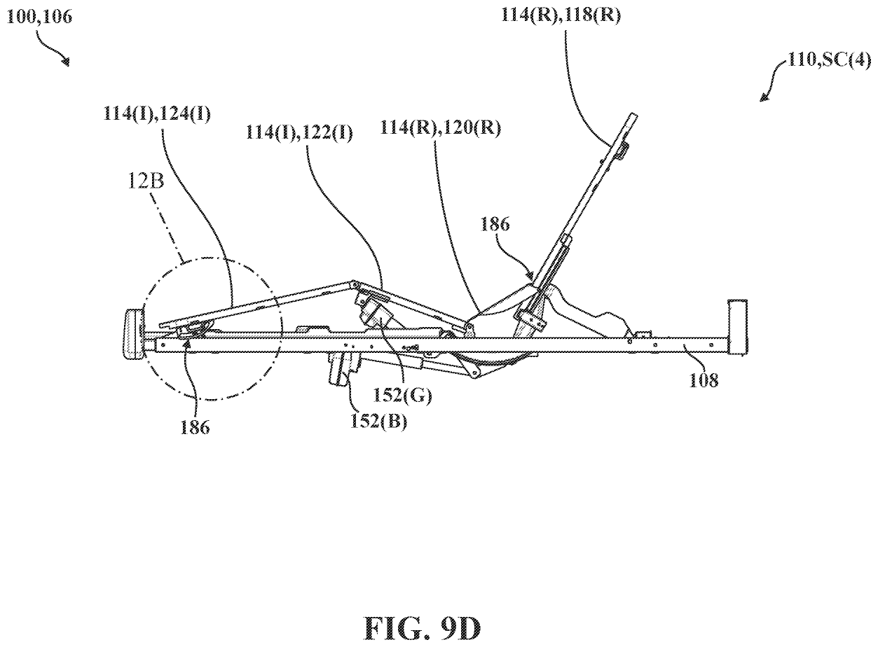

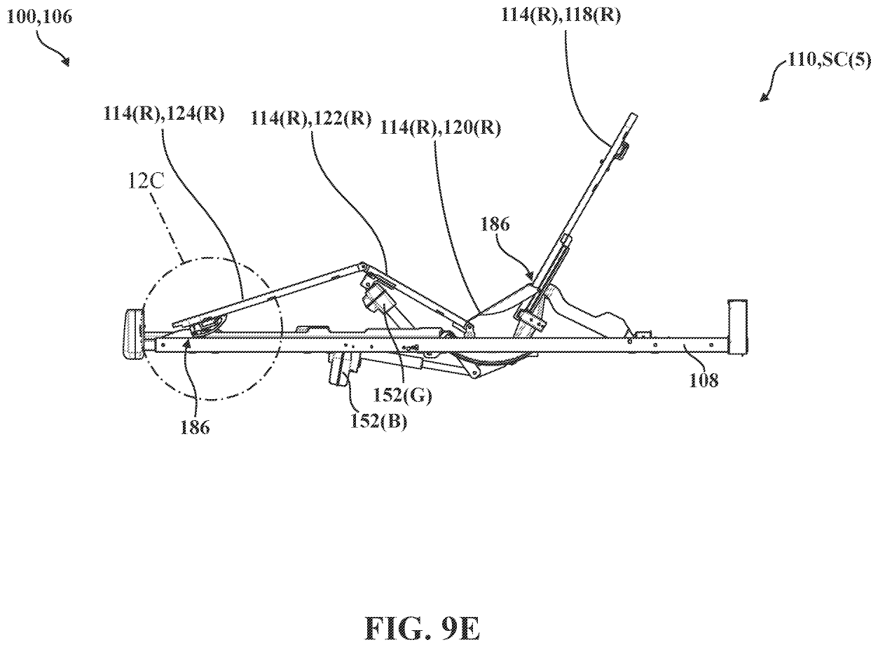

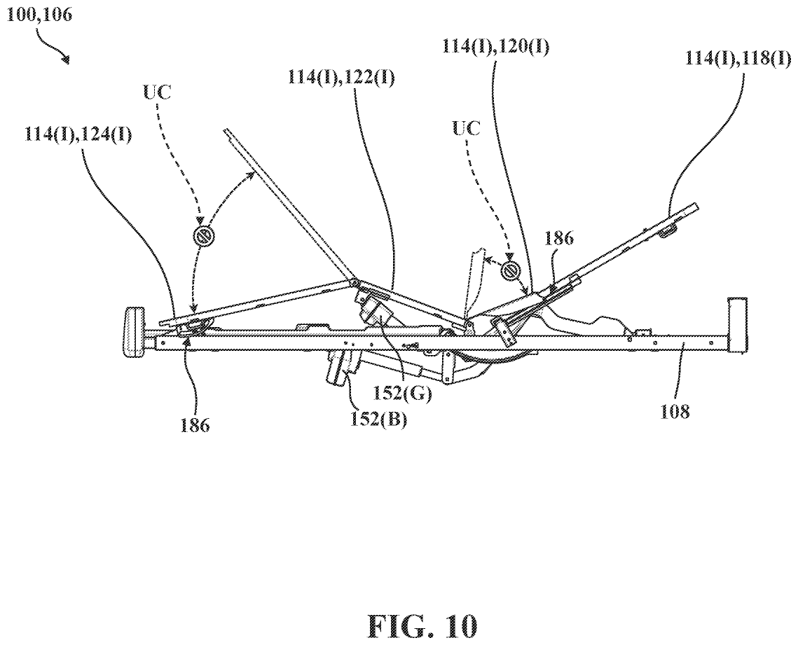

Referring now to FIG. 7, as noted above, the deck sections 114 are each arranged for movement relative to the intermediate frame 108 between a plurality of deck section positions including a first position 114L (hereinafter referred to as the lowered position 114L), a second position 114R (hereinafter referred to as the raised position 114R), and one or more intermediate positions 114I between the lowered position 114L and the raised position 114R. Here, it will be appreciated that the arrangement of the deck sections 114 of the patient support deck 110, as well as the arrangement of the lift mechanism 112, can be adjusted to define a plurality of different patient support configurations SC1, SC2, SC3, SC4, SC5 (see FIGS. 9A-9E). While a total of five predetermined patient support configurations SC1, SC2, SC3, SC4, SC5 are depicted, respectively, in FIGS. 8A-8E (and also in FIGS. 9A-9E), it will be appreciated that any suitable number of predetermined patient support configurations SC may be employed by the patient support apparatus 100 to support the patient in different ways based on the relative position of the deck sections 114 and the arrangement of the lift mechanism 112, such as by lifting or lowering one or more of the deck sections 114, and/or by tilting/leveling the intermediate frame 108 relative to the floor surface via the lift mechanism 112. Here too, it will be appreciated that the respective range of motion of the deck sections 114 and the lift members 146, 148 are each known and predetermined. Accordingly, while any suitable number of different predetermined patient support configurations SC can be defined by changes in the arrangement of at least one deck section 114 and/or at least one of the lift members 146, 148, these components are not intended to be moved beyond their predetermined ranges of motion (e.g., out of one of the predetermined patient support configurations SC). Put differently, a predetermined patient support configuration SC is defined by the patient support deck 110 and the lift mechanism 112 being arranged with its components disposed in any suitable arrangement within the respective range of motion of that component to support the patient, whereas unauthorized configurations UC (see FIG. 10) are defined with one or more components arranged outside of the range of motion of that component to support the patient along the patient support surface 116.

In order to prevent unauthorized movement of deck sections 114 away from one of the predetermined patient support configurations SC, the patient support apparatus 100 of the present disclosure employs a limiter 186 interposed between the intermediate frame 108 and the deck section 114. The limiter 186 includes a track 188 and a brace 190 movable along the track 188 in response to movement of the deck section 114 relative to the intermediate frame 108. Engagement between the brace 190 and the track 188 simultaneously permits movement of the deck section 114 between the plurality of deck section positions 114L, 114R, 114I and retains the deck section 114 relative to the intermediate frame 108 to prevent unauthorized movement of the deck section 114 away from the plurality of predetermined patient support configurations SC. Each of the components introduced above will be described in greater detail below.

Referring now to FIG. 7, as noted above, the deck sections 114 of the patient support deck 110 are each arranged for movement relative to the intermediate frame 108. To this end, the back section 118, the seat section 120, the leg section 122, and the foot section 124 each extend between respective first longitudinal ends 118A, 120A, 122A, 124A and second longitudinal ends 118B, 120B, 122B, 124B, and the litter 106 includes one or more deck pivot mounts 192, link mounts 194, and other components to facilitate adjustment of the deck sections 114. In the illustrated version, the leg section 122 includes a first gatch pivot mount 196 arranged adjacent to the first longitudinal end 122A which is pivotably coupled to the deck pivot mount 192 of the intermediate frame 108. The leg section 122 also includes a second gatch pivot mount 198 arranged adjacent to the second longitudinal end 122B which, in turn, is pivotably coupled to a third gatch pivot mount 200 arranged adjacent to the first longitudinal end 124A of the foot section 124. To facilitate movement of the leg section 122, a leg deck actuator 152G is supported between a leg actuator mount 202 coupled to the intermediate frame 108, and a leg actuator interface 204 coupled to the leg section 122. Here, one of the limiters 186 is coupled to the foot section 124 adjacent to the second longitudinal end 124B to prevent unauthorized pivoting movement of the foot section 124 relative to the leg section 122, as well as relative to the intermediate frame 108, as described in greater detail below.

As will be appreciated from the subsequent description below, various types, styles, and/or arrangements of limiters 186 for preventing unauthorized movement of various deck section 114 of the patient support deck 110 are contemplated by the present disclosure. In some versions, a single limiter 186 could be utilized to inhibit unauthorized movement of the foot section 124, whereas in other versions multiple limiters 186 could be employed to inhibit unauthorized movement of the foot section 124 (e.g., spaced on opposing lateral sides of the foot section 124). Similarly, a single limiter 186 could be utilized to inhibit unauthorized movement of the seat section 120, whereas in other versions multiple limiters 186 could be employed to inhibit unauthorized movement of the seat section 120 (e.g., spaced on opposing lateral sides of the seat section 120). Thus, in some versions, the patient support apparatus 100 could employ four or more limiters 186 (e.g., two for the foot section 124 and two for the seat section 120). However, other configurations are contemplated, and it will be appreciated that different types of litters 106 may employ different arrangements of limiters 186. By way of non-limiting example, in versions where the patient support deck 110 is configured with a seat section 120 which does not move relative to the intermediate frame 108 and the back section 118 could be otherwise moved in an unauthorized fashion (e.g., as with a manually-articulated and partially unconstrained back section 118; not shown), one or more limiters 186 could be disposed between the back section 118 and the intermediate frame 108 or another portion of the litter 106 (as opposed to between the back section 118 and the seat section 120). Similarly, in versions where the patient support deck 110 is configured with a foot section 124 which does not move concurrently with its leg section 122, one or more limiters 186 could be disposed between the intermediate frame 108, the leg section 122, and/or the foot section 124. Other configurations are contemplated.

The leg deck actuator 152G is interpose in force translating relation between the leg section 122 and the intermediate frame 108 to move the patient support deck 110 between the plurality of predetermined patient support configurations SC. It will be appreciated that, in the illustrated version, the leg deck actuator 152G controls movement of the leg section 122, and may be configured to inhibit unauthorized movement of the leg section 122 relative to the intermediate frame 108 by virtue of being non-backdrivable or otherwise difficulty to move manually. However, other configurations of the litter 106 are contemplated, including those where the patient support deck 110 does not necessarily employ deck actuators 152.

The back section 118 is pivotably coupled to the intermediate frame 108 via one or more timing links 206, and also employs a tension link 208 that is pivotably coupled to the intermediate frame 108, and a compression link 210 that is pivotably coupled to the back section 118 and to the tension link 208. The pivoting connection between the tension link 208 and the compression link 210 defines a back actuator interface 212, and a back actuator mount 214 is coupled to the intermediate frame 108, with a back deck actuator 152B coupled to the back actuator interface 212 and to the back actuator mount 214. In addition, one or more follower members 216 coupled to the back section 118 support sliders (not shown) which are supported in sliding engagement with respective curved slot members 218 that are coupled to the intermediate frame 108. Thus, the back deck actuator 152B is interposed in force translating relation between the back section 118 and the intermediate frame 108 to move the patient support deck 110 between the plurality of predetermined patient support configurations SC. Here too, it will be appreciated that, in the illustrated version, the back deck actuator 152B controls movement of the leg section 122, and may be configured to inhibit unauthorized movement of the back section 118 relative to the intermediate frame 108 by virtue of being non-backdrivable or otherwise difficulty to move manually. However, as noted above, other configurations of the litter 106 are contemplated, including those where the patient support deck 110 does not necessarily employ deck actuators 152.

The seat section 120 includes a seat pivot mount 220 arranged adjacent to the second longitudinal end 120B and pivotably coupled to the deck pivot mount 192 of the intermediate frame 108. In the illustrated version, the leg section 122 and the seat section 120 are each pivotably coupled about substantially the same axis defined by the deck pivot mount 192. However, it will be appreciated that separate deck pivot mounts 192 could be employed, either to support the leg section 122 and the seat section 120 for movement about the same axis or about different axes. Other configurations are contemplated. The seat section 120 also includes a slide interface 222 arranged adjacent to the first longitudinal end 120A which is disposed in sliding engagement with the back section 118 to effect concurrent movement of the seat section 120 with the back section 118 between the plurality of predetermined patient support configurations SC. Here, one of the limiters 186 is coupled to the back section 118 and to the seat section 120 in order to prevent unauthorized pivoting movement of the seat section 120 relative to the back section 118, as well as relative to the intermediate frame 108, as described in greater detail below.

In some versions, aspects of the litter 106 may be similar to as is described in one or more of: U.S. Patent Application No. US 2020/0107983 A1, entitled “Patient Support Apparatus With Articulating Fowler Deck Section Traveling Through Arcuate Path;” U.S. Patent Application No. US 2020/0107980 A1, entitled “Patient Support Apparatus Having Patient Support Deck And Gap Covering Deck Section;” and/or U.S. Patent Application No. US 2020/0107982 A1, entitled “Patient Support Apparatus Having Bearing Arrangement For Deck Extension Assembly;” the disclosures of each of which are incorporated by reference in their entirety.

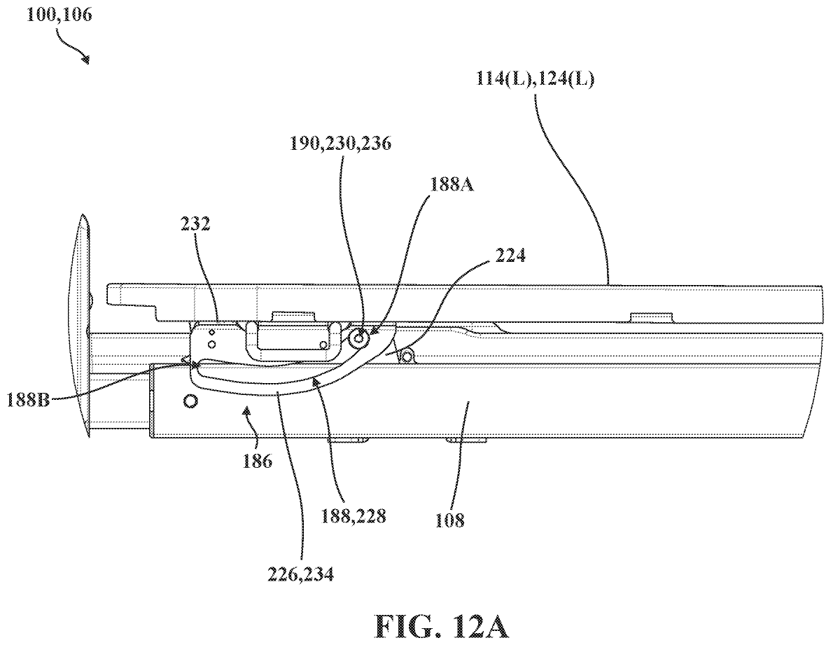

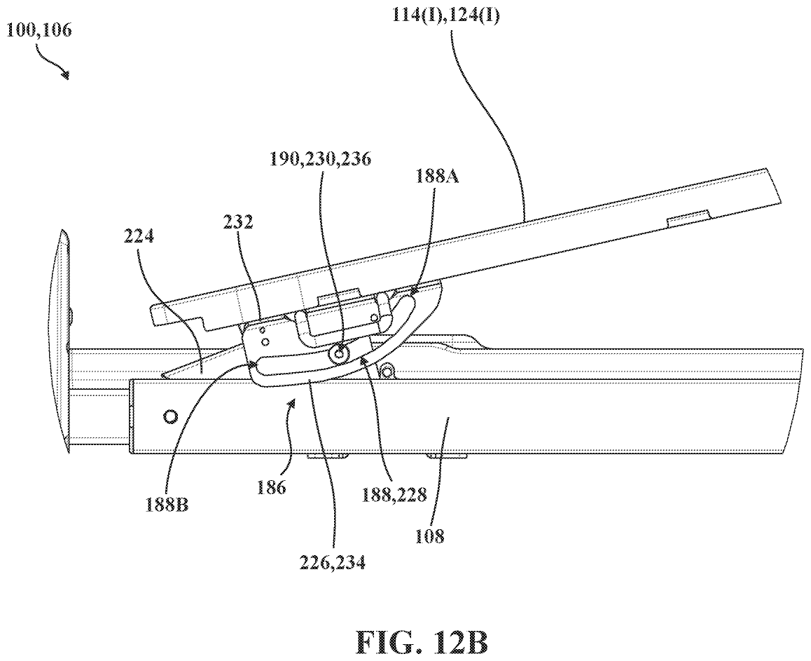

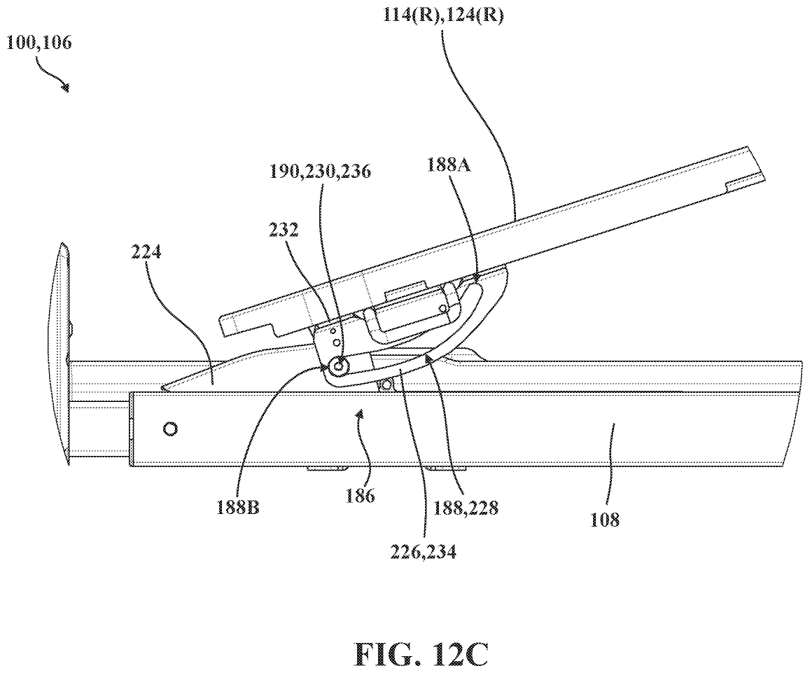

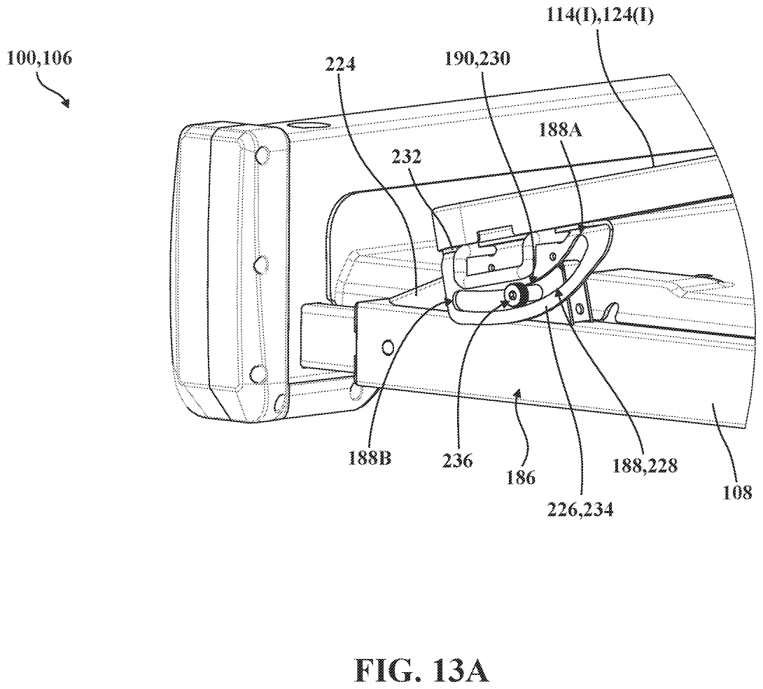

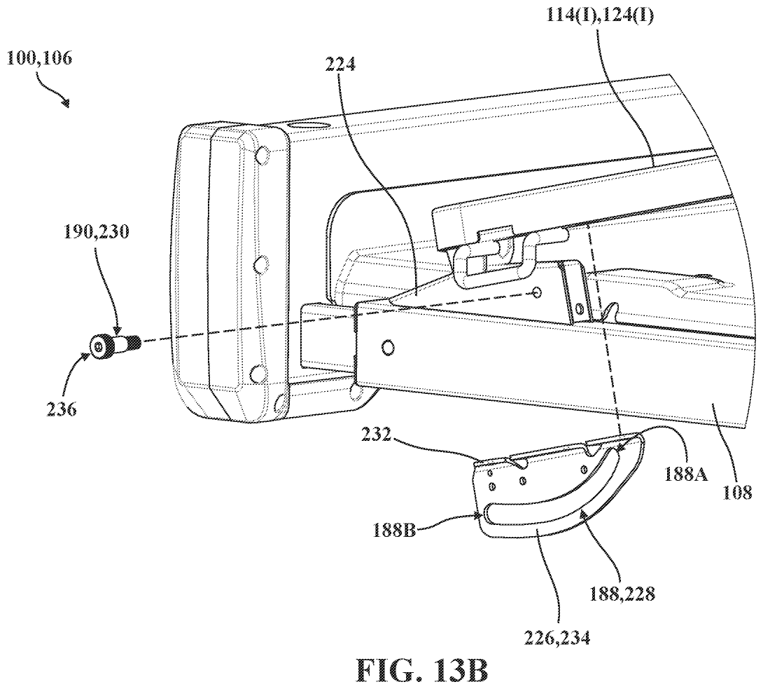

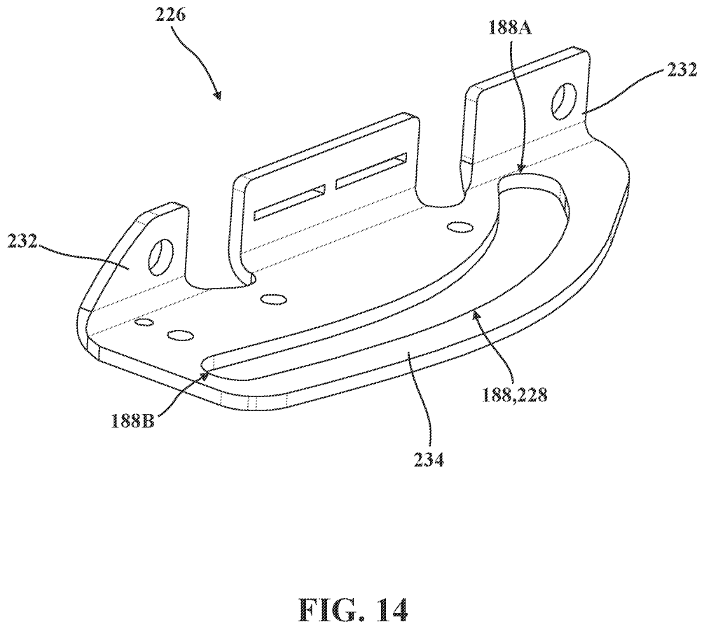

Referring now to FIGS. 12A-14, as noted above, one of the limiters 186 is coupled to the foot section 124 adjacent to the second longitudinal end 124B to prevent unauthorized pivoting movement of the foot section 124 relative to the leg section 122, as well as relative to the intermediate frame 108, based on engagement between the brace 190 and the track 188 which simultaneously permits movement of the foot section 124 between the plurality of deck section positions 124L, 124R, 124I (e.g., corresponding to the deck section positions 114L, 114R, 114I described above) and retains the foot section 124 relative to the intermediate frame 108 to prevent unauthorized movement of the foot section 124 away from one or more of the plurality of predetermined patient support configurations SC (e.g., into one or more unauthorized configurations UC such as is depicted in FIG. 10).

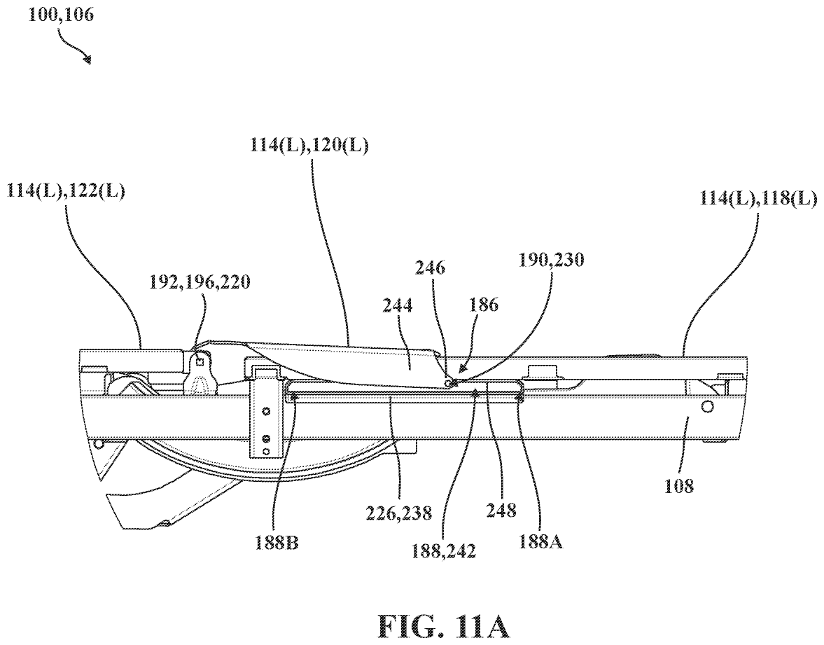

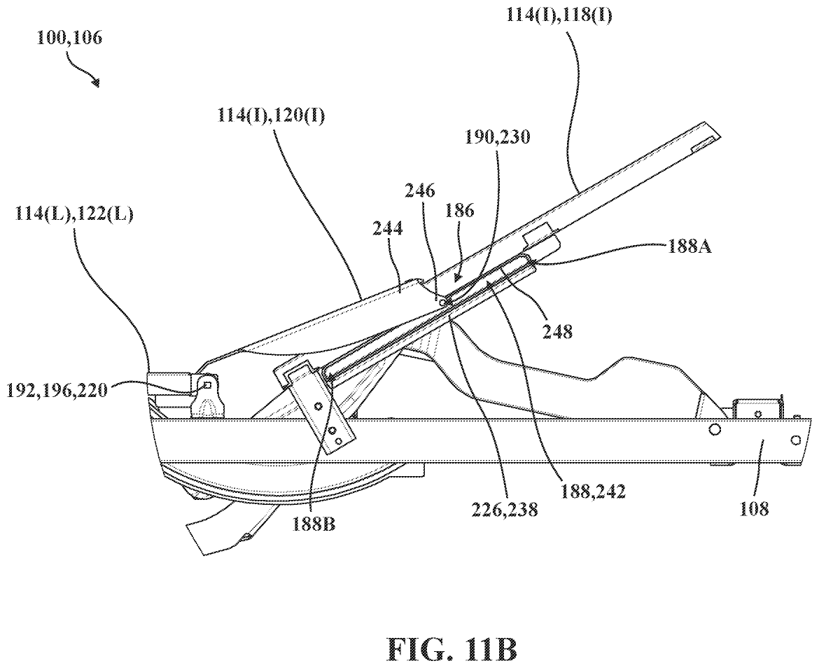

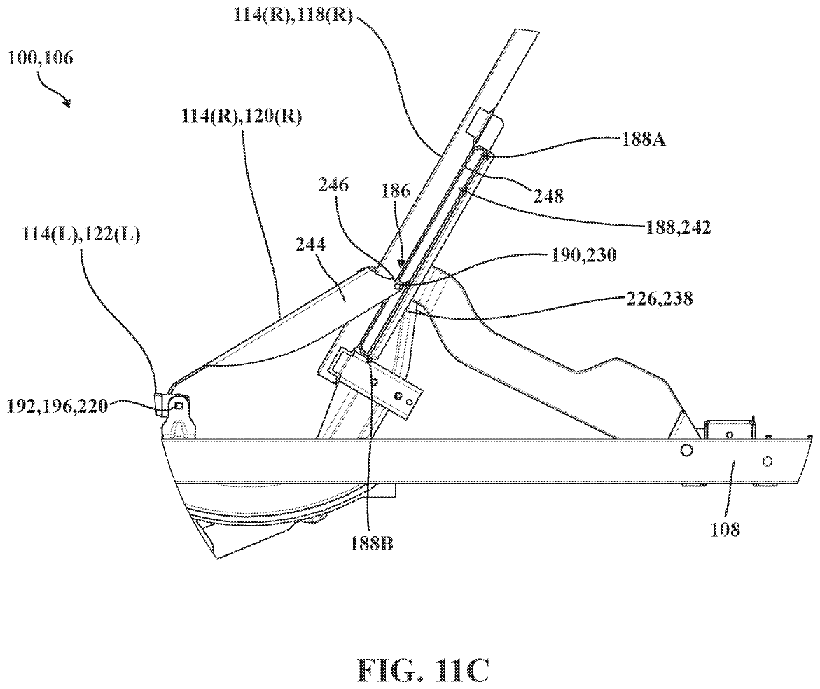

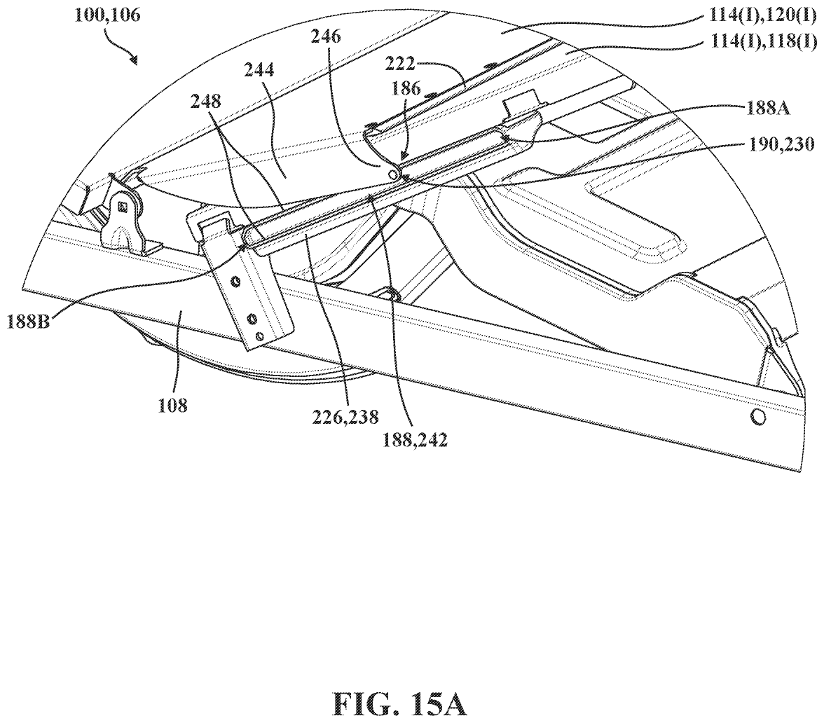

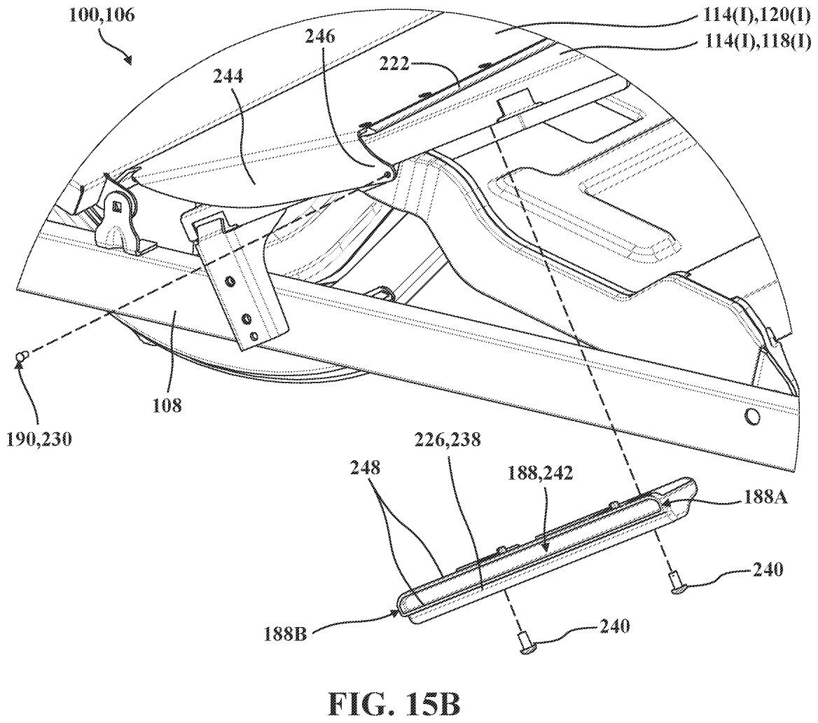

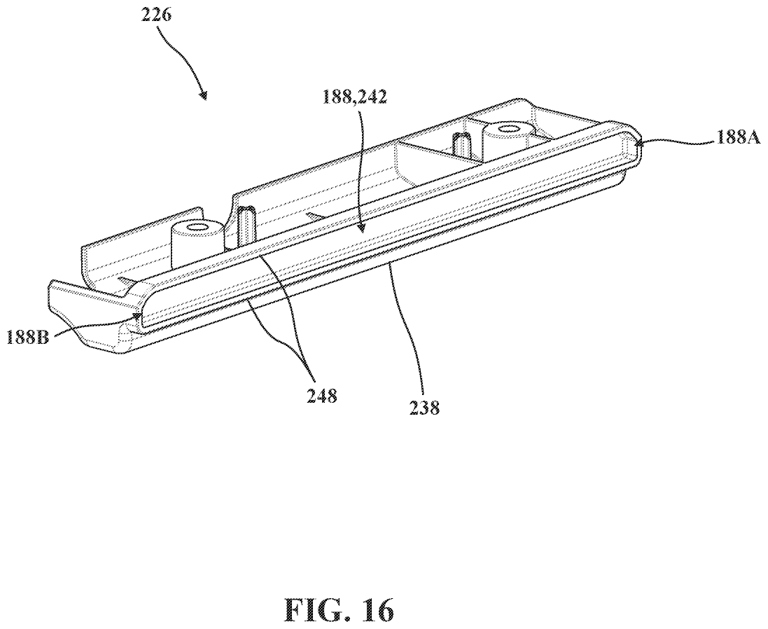

In this version, the limiter 186 is interposed between the patient support deck 110 and the intermediate frame 108 as noted above, but other configurations are contemplated (e.g., such as between different portions of the patient support deck 110, as described in greater detail below in connection with FIGS. 11A-11C and 15A-16). More specifically, and as is best depicted in FIGS. 12A-12C, in this version, the track 188 is operatively attached to the deck section 114 (here, the foot section 124) of the patient support deck 110 for concurrent movement with the deck section 114 between the plurality of deck section positions 114L, 114R, 114I (here, deck section positions 124L, 124R, 124I), and the brace 190 is operatively attached to the intermediate frame 108. To this end, in the illustrated version, a mount 224 is operatively attached to the intermediate frame 108 and supports the brace 190. In some versions, the mount 224 may be similar to as is described in U.S. Patent Application No. US 2020/0107982 A1, previously referenced. Other configurations are contemplated.

With continued reference to the version depicted in FIGS. 12A-14, the limiter 186 includes a bracket 226 which is coupled to the deck section 114 (here, adjacent to the second longitudinal end 124B of the foot section 124) and defines the track 188. More specifically, in this version, the bracket 226 includes a slot 228, and the brace 190 includes a shaft 230 which extends from the mount 224, is disposed along the track 188, and extends into the slot 228. In this version, the slot 228 has a curved profile which permits the foot section 124 to move between the plurality of deck section positions 124L, 124R, 124I. More specifically, the bracket 226 has a bracket mount 232 which is operatively attached to the deck section 114, such as by one or more fasteners (not shown), and a plate 234 which depends from the bracket mount 232 and defines the slot 228. The slot 228 has a closed profile formed in the plate 234, and is shaped and arranged to permit movement of the shaft 230 along the track 188 but also restricts movement of the shaft 230 beyond the track 188. Here, the brace 190 also includes a stop 236 coupled to the shaft 230, and the plate 234 of the bracket 226 is arranged laterally between the stop 236 and the mount 224 to, among other things, inhibit unintended lateral movement of the deck section 114 and prevent unintended disengagement of the brace 190 from the track 188. As will be appreciated from the subsequent description below, various configurations and arrangements of the track 188 and the brace 190 of the limiter 186 are contemplated by the present disclosure, including with interposed arrangements (e.g., where the track 188 is coupled to the intermediate frame 108 rather than to the deck section 114), and or with differently configured components (e.g., where the track 188 is defined by a different type of bracket 226 or other structure, with or without a slot 228 having a closed and/or curved profile). Other configurations are contemplated.

The track 188 of the limiter 186 defines a first track end 188A and a second track end 188B, and the brace 190 is arranged for movement towards the second track end 188B in response to movement of the deck section 114 (here, the foot section 124) towards the lowered position 114L (here, lowered position 124L). The brace 190 is arranged for movement towards the first track end 188B in response to movement of the deck section 114 (here, the foot section 124) towards the raised position 114R (here, raised position 124R).

In this version, the brace 190 is realized as a threaded fastener defining the shaft 230 and the stop 236, which may feature a security-bit type head (not shown in detail) or other interface at the stop 236 to inhibit unauthorized removal of the brace 190 from the mount 224. In some versions, a lock mechanism (not shown) may be utilized in addition or in place of the threaded fastener. Other configurations are contemplated. Here, the retention afforded by the limiter 186 ensures that the deck section 114 (here, the foot section 124) cannot be moved in an unauthorized fashion, such as by a patient presenting behavioral health indicia, which helps promote patient safety and also helps inhibit tampering with components of the patient support apparatus 100 which are disposed underneath the deck section 114. Here too, it will be appreciated that the limiter 186 may also be configured to be released by authorized personnel (e.g., a caregiver, a technician, and the like), such as by using a tool to remove the brace 190 out of engagement with the track 188 in order to facilitate cleaning, services, and the like of the patient support apparatus 100.

Referring now to FIGS. 11A-11C and 15A-16, as noted above, one of the limiters 186 is coupled between portions of the patient support deck 110 to prevent unauthorized pivoting movement of the seat section 120 relative to the back section 118, as well as relative to the intermediate frame 108, based on engagement between the brace 190 and the track 188 which simultaneously permits movement of the seat section 120 between the plurality of deck section positions 120L, 120R, 120I (e.g., corresponding to the deck section positions 114L, 114R, 114I described above) and retains the seat section 120 relative to the intermediate frame 108 to prevent unauthorized movement of the seat section 120 away from one or more of the plurality of predetermined patient support configurations SC (e.g., into one or more unauthorized configurations UC such as is depicted in FIG. 10).

In this version, the limiter 186 is operatively attached to the deck section 114 for concurrent movement with the deck section 114 between the plurality of deck section positions 114L, 114R, 114I. More specifically, in this version, the track 188 of the limiter 186 is operatively attached to the back section 118 for concurrent movement with the back section 118, and the brace 190 is operatively attached to the seat section 120 for concurrent movement with the seat section 120. In this version, the limiter 186 includes a differently-configured bracket 226 (e.g., compared to the version described above in connection with FIGS. 12A-14). Here in this version, the bracket 226 has an elongated body 238 defining the bracket mount 232, which is coupled to the back section 118 via one or more fasteners 240, and the elongated body 238 also includes a channel 242 which defines the track 188 in this version and has a generally straight profile arranged substantially parallel to the back section 118. In this version, the brace 190 is coupled to the seat section 120 adjacent to the first longitudinal end 120A to prevent unauthorized pivoting movement of the seat section 120 relative to the back section 118, and includes a hanger 244 coupled to the seat section 120 which extends adjacent to and below the slide interface 222 to define a hanger flange 246 which, in turn, supports the shaft 230. The hanger flange 246 may be formed integrally with a portion of the seat section 120, such as by a stamped piece of sheet metal or another suitable material. In some versions, the hanger flange 246 may be formed as a separate component which is operatively attached to the seat section 120 such as by fasteners, adhesives, welding, and the like. Other configurations are contemplated.

In this version, the shaft 230 is arranged extending into the channel 242 and is supported for movement disposed along the track 188. The channel 242 has a recessed profile defined by channel walls 248 which may abut the shaft 230 and which generally define the track 188. While the channel walls 248 extend about the channel 242 with a closed profile in this version, it will be appreciated that channel walls 248 adjacent to the first and second track ends 188A, 188B of the track 188 could be omitted in some versions where the channel 242 is configured with a length that is larger than is necessitated by the range of motion of the back section 118 and/or the seat section 120. Put differently, the channel 242 could be long enough to ensure that the shaft 230 of the brace 190 cannot be removed from the channel in the longitudinal direction, even where the channel 242 is configured with “open” ends (not shown).

Here too, it will be appreciated that the retention afforded by the limiter 186 ensures that the deck section 114 (here, the seat section 120) cannot be moved in an unauthorized fashion, such as by a patient presenting behavioral health indicia, which helps promote patient safety and also helps inhibit tampering with components of the patient support apparatus 100 which are disposed underneath the deck section 114. Here too, it will be appreciated that the limiter 186 may also be configured to be released by authorized personnel (e.g., a caregiver, a technician, and the like), such as by using a tool to remove the fasteners 240 securing the elongated body 238 to the back section 118 to bring the brace 190 out of engagement with the track 188 in order to facilitate cleaning, services, and the like of the patient support apparatus 100.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

What is claimed is:

1. A patient support apparatus for use in treating patients with behavioral health indicia, the patient support apparatus comprising:
an intermediate frame;
a patient support deck having a deck section arranged for movement relative to the intermediate frame between a plurality of deck section positions to define a plurality of predetermined patient support configurations; and
a limiter interposed between the intermediate frame and the deck section and including a track and a brace movable along the track in response to movement of the deck section, wherein engagement between the brace and the track simultaneously permits movement of the deck section between the plurality of deck section positions and retains the deck section relative to the intermediate frame to prevent unauthorized movement of the deck section away from the plurality of predetermined patient support configurations.

2. The patient support apparatus of claim 1, wherein the track is operatively attached to the patient support deck.

3. The patient support apparatus of claim 2, wherein the track is operatively attached to the deck section for concurrent movement with the deck section between the plurality of deck section positions.

4. The patient support apparatus of claim 3, wherein the brace is operatively attached to the intermediate frame.

5. The patient support apparatus of claim 4, wherein the limiter includes a bracket coupled to the deck section and defining the track.

6. The patient support apparatus of claim 5, wherein the brace includes a shaft disposed along the track;
wherein the bracket includes a slot defining the track, with the shaft of the brace extending into the slot; and
wherein the slot has a curved profile.

7. The patient support apparatus of claim 6, further comprising a mount operatively attached to the intermediate frame and supporting the brace; and
wherein the brace further includes a stop coupled to the shaft, with the bracket arranged laterally between the stop and the mount.

8. The patient support apparatus of claim 1, wherein the deck section is further defined as a foot section; and
wherein the patient support deck further includes a leg section pivotably coupled to the intermediate frame and to the foot section for concurrent movement with the foot section between the plurality of predetermined patient support configurations.

9. The patient support apparatus of claim 8, wherein the foot section and the leg section each extend between respective first and second longitudinal ends;
wherein the intermediate frame includes a deck pivot mount;
wherein the leg section includes:
a first gatch pivot mount arranged adjacent to the first longitudinal end of the leg section and pivotably coupled to the deck pivot mount of the intermediate frame, and
a second gatch pivot mount arranged adjacent to the second longitudinal end of the leg section; and
wherein the foot section includes a third gatch pivot mount arranged adjacent to the first longitudinal end of the foot section and pivotably coupled to the second gatch pivot mount.

10. The patient support apparatus of claim 9, wherein the track of the limiter is coupled to the foot section adjacent to the second longitudinal end of the foot section to prevent unauthorized pivoting movement of the foot section relative to the leg section; and
further including a leg deck actuator interposed in force translating relation between the leg section and the intermediate frame to move the patient support deck between the plurality of predetermined patient support configurations.

11. The patient support apparatus of claim 9, wherein the track of the limiter is coupled to the foot section adjacent to the second longitudinal end of the foot section to prevent unauthorized pivoting movement of the foot section relative to the leg section;
wherein the limiter includes a bracket coupled to the foot section adjacent to the second longitudinal end of the foot section, the bracket including a slot defining the track; and
wherein the brace includes a shaft extending into the slot of the bracket and operatively attached the intermediate frame.

12. The patient support apparatus of claim 1, wherein the plurality of deck section positions include a raised position and a lowered position; and
wherein the track defines a first track end and a second track end, with the brace arranged for movement towards the second track end in response to movement of the deck section towards the lowered position.

13. The patient support apparatus of claim 1, wherein the brace is operatively attached to the deck section for concurrent movement with the deck section between the plurality of deck section positions.

14. The patient support apparatus of claim 13, wherein the deck section is further defined as a seat section; and
wherein the patient support deck further includes a back section pivotably coupled to the intermediate frame and supporting the seat section for concurrent movement with the back section between the plurality of predetermined patient support configurations.

15. The patient support apparatus of claim 14, wherein the intermediate frame includes a deck pivot mount; and
wherein the seat section extends between first and second longitudinal ends and includes:
a seat pivot mount arranged adjacent to the second longitudinal end and pivotably coupled to the deck pivot mount of the intermediate frame, and
a slide interface arranged adjacent to the first longitudinal end and disposed in sliding engagement with the back section.

16. The patient support apparatus of claim 15, wherein the brace is coupled to the seat section adjacent to the first longitudinal end to prevent unauthorized pivoting movement of the seat section relative to the back section.

17. The patient support apparatus of claim 16, wherein the track is operatively attached to the back section for concurrent movement with the back section between the plurality of deck section positions.

18. The patient support apparatus of claim 17, wherein the limiter includes a bracket coupled to the back section and defining the track; and
wherein the brace includes a hanger and a shaft coupled to the hanger adjacent to and below the slide interface of the seat section, with the shaft disposed along the track.

19. The patient support apparatus of claim 18, wherein the bracket includes a channel defining the track, with the shaft of the brace extending into the channel; and
wherein the channel has a straight profile.

20. The patient support apparatus of claim 19, wherein the back section extends between first and second longitudinal ends;
wherein the bracket is operatively attached to the back section and is arranged closer to the second longitudinal end than to the first longitudinal end; and
further including a back deck actuator interposed in force translating relation between the back section and the intermediate frame to move the patient support deck between the plurality of predetermined patient support configurations.
